(19) United States
(12) Patent Application Publication
(10) Pub. No.: US 2026/0236164 A1
(43) Pub. Date: Aug. 13, 2026

(54) METHOD OF MANAGING METADATA IN KEY-VALUE STORE BASED ON LSM-TREE, AND STORAGE DEVICE AND STORAGE SYSTEM PERFORMING THE SAME

(71) Applicant: Samsung Electronics Co., Ltd., Suwon-si (KR)

(72) Inventors: Jeongmin HAN, Suwon-si (KR); Jinkyu JEONG, Seoul (KR); Minwoo AHN, Bucheon-si (KR)

(73) Assignees: Samsung Electronics Co., Ltd., Suwon-si (KR); UIF (University Industry Foundation), Yonsei University, Seoul (KR); RESEARCH & BUSINESS FOUNDATION SUNGKYUNKWAN UNIVERSITY, Gyeonggi-do (KR)

(21) Appl. No.: 19/323,179

(22) Filed: Sep. 9, 2025

(30) Foreign Application Priority Data
Feb. 10, 2025 (KR) 10-2025-0016849

(51) Int. Cl. G06F 3/06

(52) U.S. Cl. CPC G06F 3/0604; G06F 3/064; G06F 3/0679

(57) ABSTRACT

In a method of managing metadata in key-value store based on LSM-tree, key-value pairs are sequentially stored in a memory table. Filter information, data index information, and top-level index information are generated. The filter information and the data index information correspond to the key-value pairs. The top-level index information correspond to the filter information and the data index information. A first sorted string table having a first structure is generated such that the top-level index information are included in a unified top-level block, the filter information and the data index information are included in unified partition blocks, at least one filter information and at least one data index information are included in one unified partition block, and the key-value pairs are included data blocks. The first sorted string table is stored.

### CROSS-REFERENCE TO RELATED APPLICATION

This application claims priority under 35 USC § 119 to Korean Patent Application No. 10-2025-0016849 filed on Feb. 10, 2025 in the Korean Intellectual Property Office (KIPO), the contents of which are herein incorporated by reference in their entirety.

### BACKGROUND

### 1. Technical Field

Example embodiments relate generally to semiconductor integrated circuits, and more particularly to methods of managing metadata in key-value store based on log-structured merge tree (LSM-tree), storage devices performing the methods, and storage systems performing the methods.

### 2. Description of the Related Art

One or more semiconductor memory devices may be used in data storage devices. Examples of such data storage devices include solid state drives (SSDs). SSDs typically use flash memory and function as secondary storage. SSDs have various design and/or performance advantages over hard disk drives (HDDs). Examples include the absence of moving mechanical parts, higher data access speeds, stability, durability, and/or low power consumption. Various systems, e.g., a laptop computer, a car, an airplane, a drone, etc., have adopted SSDs for data storage.

In a data storage system for massive data storage, a key-value database (or key-value store) may be an important database type. As compared with a traditional relational database, a key-value database may use keys to identify data rows, not limited to a fixed data table structure, thus saving time and space overhead, and reducing the number of reads and writes to the disk and improving read and write performance.

### SUMMARY

At least one example embodiment of the present disclosure provides methods of more efficiently managing metadata in key-value store based on log-structured merge tree (LSM-tree).

At least one example embodiment of the present disclosure provides storage devices and storage systems performing the method of managing metadata.

According to example embodiments, in a method of managing metadata in key-value store based on LSM-tree, a plurality of key-value pairs are sequentially stored in a memory table. A plurality of filter information, a plurality of data index information, and a plurality of top-level index information are generated. The plurality of filter information and the plurality of data index information correspond to the plurality of key-value pairs. The plurality of top-level index information correspond to the plurality of filter information and the plurality of data index information. A first sorted string table having a first structure is generated such that the plurality of top-level index information are included in a unified top-level block, the plurality of filter information and the plurality of data index information are included in a plurality of unified partition blocks, at least one filter information and at least one data index information are included in one unified partition block, and the plurality of key-value pairs are included in a plurality of data blocks. The first sorted string table is stored.

According to example embodiments, a storage device includes a storage controller and a plurality of nonvolatile memories. The storage controller is configured to receive a first sorted string table having a first structure such that a plurality of top-level index information are included in a unified top-level block, a plurality of filter information and a plurality of data index information are included in a plurality of unified partition blocks, at least one filter information and at least one data index information are included in one unified partition block, and a plurality of key-value pairs are included in a plurality of data blocks. The plurality of key-value pairs are used in key-value store based on log-structured merge tree (LSM-tree). The plurality of filter information and the plurality of data index information correspond to the plurality of key-value pairs. The plurality of top-level index information correspond to the plurality of filter information and the plurality of data index information. The plurality of nonvolatile memories are configured to store the first sorted string table. The storage controller is configured to control the plurality of nonvolatile memories.

According to example embodiments, a storage system includes a host device and a storage device. The host device is configured to sequentially store a plurality of key-value pairs in a memory table, generate a plurality of filter information, a plurality of data index information and a plurality of top-level index information, and generate a first sorted string table having a first structure and a second sorted string table having a second structure different from the first structure. The storage device is configured to store the first sorted string table and the second sorted string table. The first sorted string table having the first structure is implemented such that the plurality of top-level index information are included in a unified top-level block, the plurality of filter information and the plurality of data index information are included in a plurality of unified partition blocks, at least one filter information and at least one data index information are included in one unified partition block, and the plurality of key-value pairs are included in a plurality of data blocks. The second sorted string table having the second structure is implemented such that the plurality of filter information are included in a filter block, the plurality of data index information are included in a data index block, and the plurality of key-value pairs are included in the plurality of data blocks. The host device is configured to, based on read requests being processed, monitor access information for the first sorted string table and the second sorted string table. The storage device is configured to perform a cost-benefit analysis for the first sorted string table and the second sorted string table based on a result of monitoring the access information, select one of the first sorted string table and the second sorted string table based on a result of the cost-benefit analysis, and provide a selected sorted string table to the host device. The host device is configured to perform a metadata caching operation using the selected sorted string table.

In the method of managing metadata, in the storage device and the storage system according to example embodiments, the plurality of filter information and the plurality of data index information may be stored in the plurality of unified partition blocks, and at least one filter information and at least one data index information may be stored together in a single unified partition block. In other words, the filter information and the data index information may be managed in a unified manner. Additionally, the unified top-level block that stores the plurality of top-level index information for indexing the plurality of filter information and the plurality of data index information may be formed. In the sorted string table according to example embodiments, only the unified top-level block and a specific unified partition block need to be cached, and the unified top-level block and the specific unified partition block may be sequentially accessed based on read requests being processed. Accordingly, a relatively smaller amount of memory space may be used for caching, the number of accesses to metadata block may be relatively less, and the metadata may be more efficiently managed, processed and/or treated.

Moreover, in example embodiments, both the conventional flat structure and the new unified hierarchical structure may be used together, and the metadata structure for each sorted string table may be dynamically and/or adaptively determined using the cost-benefit analysis based on monitoring the access information for each sorted string table. Accordingly, the metadata may be more efficiently managed and the device and/or methods may be improved.

### BRIEF DESCRIPTION OF THE DRAWINGS

Illustrative, non-limiting example embodiments will be more clearly understood from the following detailed description taken in conjunction with the accompanying drawings.

FIG. 1 is a flowchart illustrating a method of managing metadata according to example embodiments.

FIG. 2 is a block diagram illustrating a storage device and a storage system including the storage device according to example embodiments.

FIG. 3 is a diagram for describing a method of managing metadata according to example embodiments.

FIGS. 4A, 4B, 4C, 4D, 4E, and 4F are diagrams for describing a memory table and a first sorted string table that are generated by a method of managing metadata according to example embodiments.

FIG. 5 is a flowchart illustrating an example of generating a first sorted string table in FIG. 1.

FIG. 6 is a flowchart illustrating an example of allocating i-th filter information and i-th data index information in FIG. 5.

FIG. 7 is a flowchart illustrating an example of allocating i-th key-value pair in FIG. 5.

FIG. 8 is a flowchart illustrating an example of generating a first sorted string table in FIG. 1.

FIG. 9 is a diagram for describing a first sorted string table generated by a method of managing metadata according to example embodiments.

FIG. 10 is a diagram for describing a method of managing metadata according to example embodiments.

FIG. 11 is a flowchart illustrating a method of managing metadata according to example embodiments.

FIGS. 12A, 12B, 12C, and 12D are diagrams for describing a second sorted string table generated by a method of managing metadata according to example embodiments.

FIG. 13 is a diagram for describing a method of managing metadata according to example embodiments.

FIG. 14 is a flowchart illustrating a method of managing metadata according to example embodiments.

FIG. 15 is a block diagram illustrating a storage device and a storage system including the storage device according to example embodiments.

FIG. 16 is a flowchart illustrating an example of selecting one of a first sorted string table and a second sorted string table in FIG. 14.

FIGS. 17A, 17B, and 18 are diagrams for describing a metadata caching operation in FIG. 14.

FIG. 19 is a flowchart illustrating a method of managing metadata according to example embodiments.

FIGS. 20, 21, and 22 are flowcharts illustrating a method of operating a storage device according to example embodiments.

FIG. 23 is a block diagram illustrating an example of a storage controller included in a storage device according to example embodiments.

FIG. 24 is a block diagram illustrating an example of a nonvolatile memory included in a storage device according to example embodiments.

FIG. 25 is a block diagram illustrating a data center including a storage device according to example embodiments.

### DETAILED DESCRIPTION

Various example embodiments will be described more fully with reference to the accompanying drawings, in which embodiments are shown. The present disclosure may, however, be embodied in many different forms and should not be construed as limited to the embodiments set forth herein. Like reference numerals refer to like elements throughout this application.

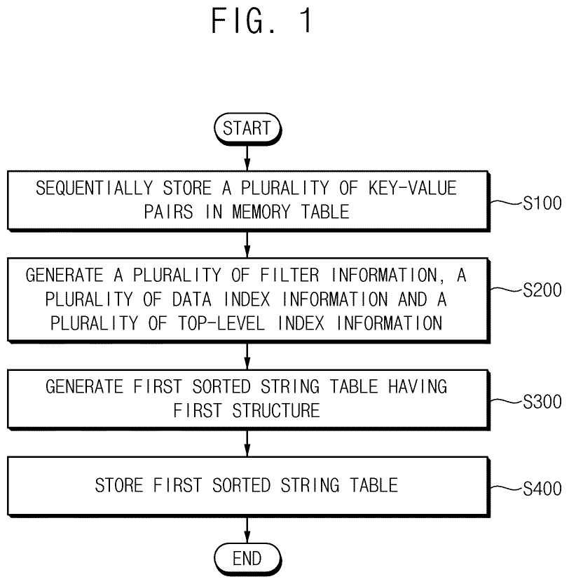

FIG. 1 is a flowchart illustrating a method of managing metadata according to example embodiments.

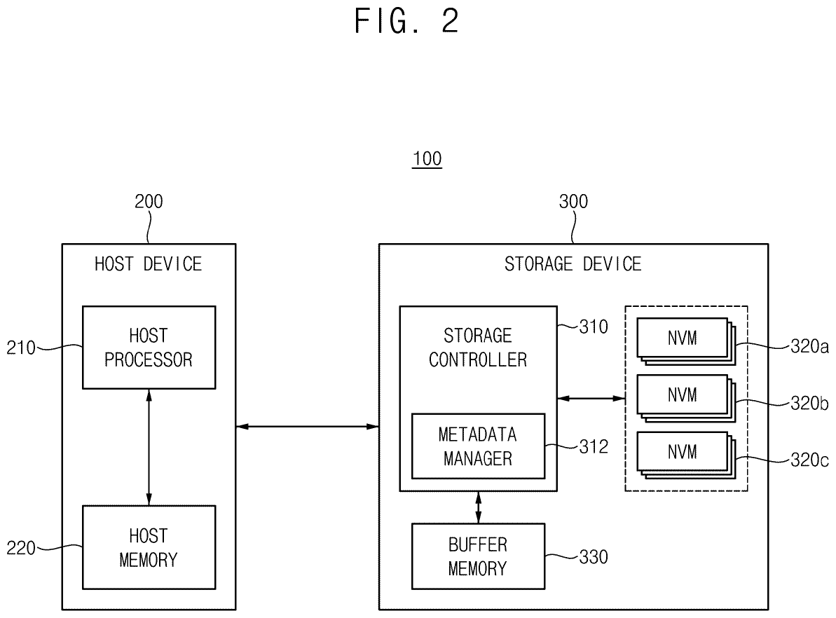

Referring to FIG. 1, a method of managing metadata according to example embodiments is performed during an execution of key-value store based on log-structured merge tree (LSM-tree), and is performed by a storage system including a host device and a storage device. The storage system including the host device and the storage device will be described with reference to FIG. 2.

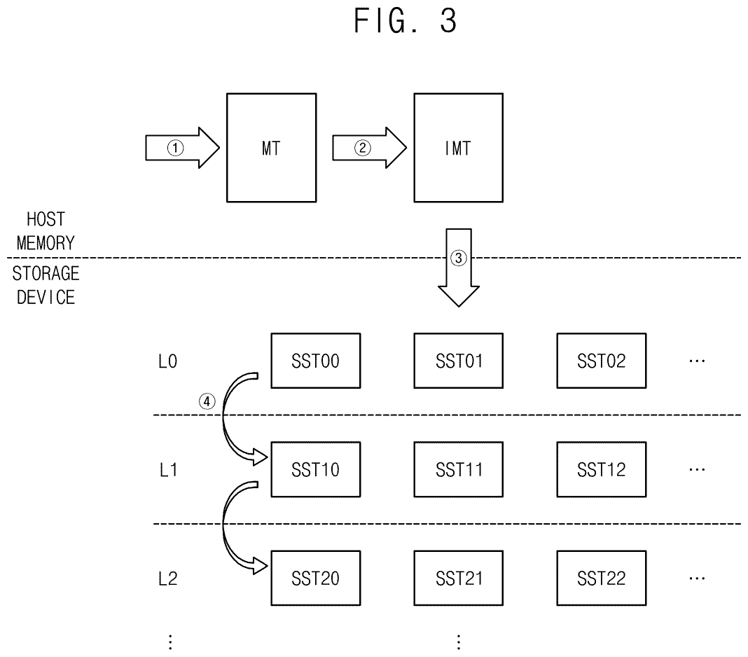

In the method of managing metadata according to example embodiments, a plurality of key-value pairs are sequentially stored in a memory table (operation S100). For example, the memory table may be stored in a host memory included in the host device. The memory table will be described with reference to FIG. 3.

A plurality of filter information, a plurality of data index information and a plurality of top-level index information are generated (operation S200). The plurality of filter information and the plurality of data index information correspond to the plurality of key-value pairs, and the plurality of top-level index information correspond to the plurality of filter information and the plurality of data index information. For example, the plurality of filter information, the plurality of data index information, and the plurality of top-level index information may be metadata associated with or related to the plurality of key-value pairs.

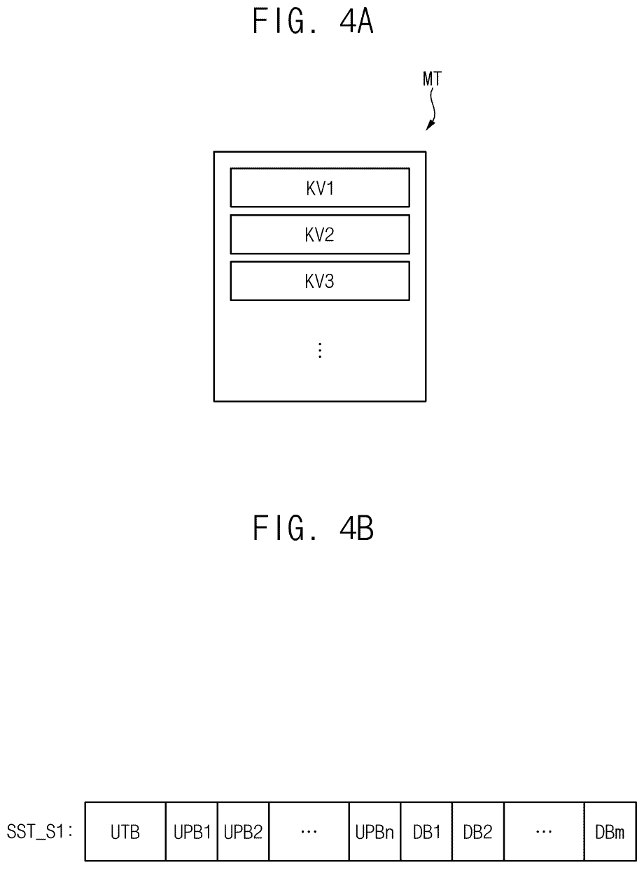

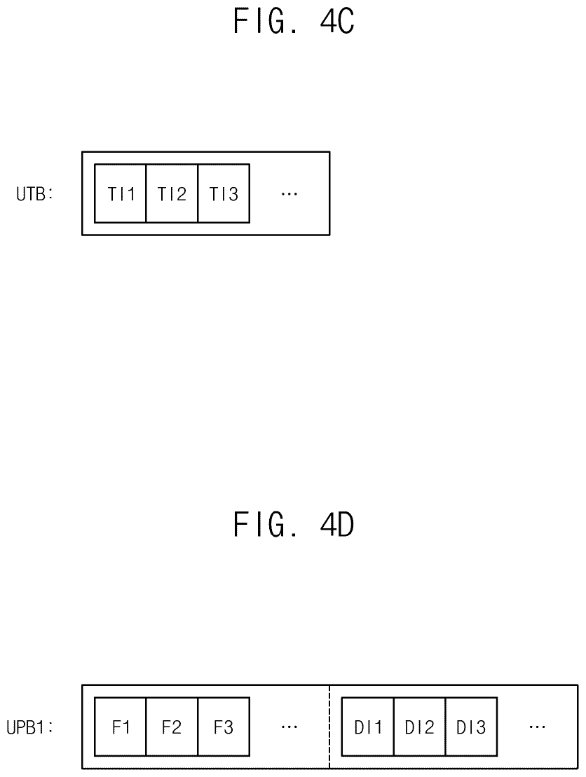

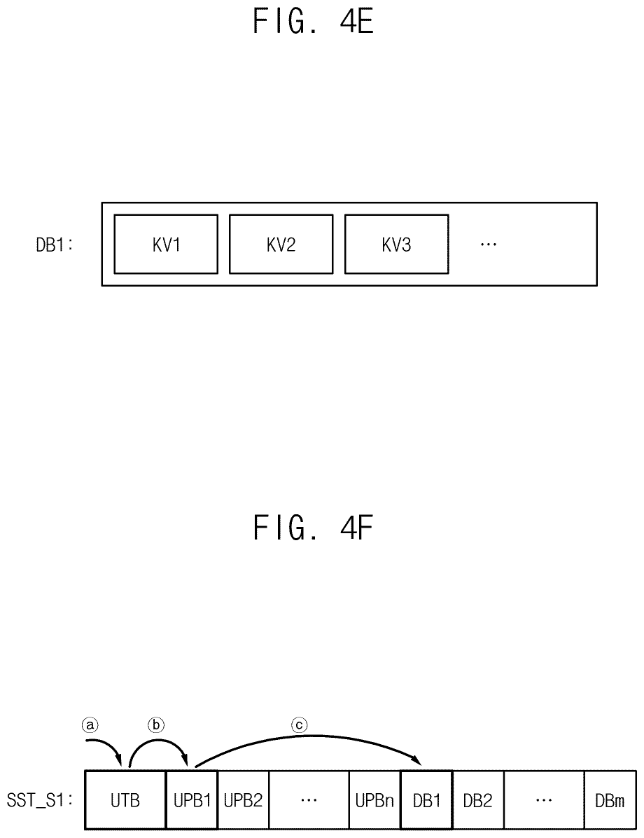

A first sorted string table having a first structure is generated or implemented such that the plurality of top-level index information are included in a unified top-level block, the plurality of filter information and the plurality of data index information are included in a plurality of unified partition blocks, at least one filter information and at least one data index information are included in one unified partition block, and the plurality of key-value pairs are included in a plurality of data blocks (operation S300). The first sorted string table is stored (operation S400). For example, the first sorted string table may be stored in at least one nonvolatile memory included in the storage device. The sorted string table will be described with reference to FIGS. 3, 4A, 4B, 4C, 4D, 4E, and 4F.

In a data storage system for massive data storage, key-value store may be used. The key-value store may use keys to identify data rows, not limited to a fixed data table structure. The key-value store may be implemented using a log-structured merge tree (LSM-Tree). Data storage systems based on the LSM-Tree may include the existing RocksDB structure or LevelDB structure, etc. For example, the data storage system based on the LSM-Tree may include a memory layer and a persistence layer.

In the memory layer, key-value pairs may be stored in a memory table and an immutable memory table, and the memory table and the immutable memory table may together form a structure for organizing and maintaining data in a memory. In the persistence layer, key-value pairs may be stored in data files in multiple hierarchies. For example, the persistence layer may be implemented by hardware such as a solid-state drive (SSD). For example, a sorted string table may be a data file used to store key-value pairs.

Conventionally, a sorted string table was implemented to have two different structures. One structure is a flat structure and the other structure is a hierarchical structure. In the flat structure and the hierarchical structure, the operation of storing and/or managing metadata (e.g., filter information and index information) associated with key-value pairs may be different.

The flat structure may include one filter block that stores filter information and one data index block that stores data index information. In the flat structure, the entire filter block and the entire data index block should be cached, and the entire filter block and the entire data index block may be sequentially accessed when read requests are processed. For example, when using the flat structure, a number of accesses to metadata block would be relatively lower (e.g., two times) than the hierarchical structure, but a remaining problem would be a relatively larger amount of memory space used for caching. In other words, the flat structure may make information more accessible in the metadata block at the cost of cache memory space.

The hierarchical structure may include a plurality of filter partition blocks corresponding to a filter block and a plurality of data index partition blocks corresponding to a data index block. In the hierarchical structure, filter information may be divided into a plurality of filter information, data index information may be divided into a plurality of data index information, and the plurality of filter information and the plurality of data index information may be stored in the plurality of filter partition blocks and the plurality of data index partition blocks, respectively. In addition, the hierarchical structure may further include a top-level filter block that stores first top-level index information for indexing the plurality of filter information, and may further include a top-level index block that stores second top-level index information for indexing the plurality of data index information. In the hierarchical structure, only the top-level filter block, a specific filter partition block, the top-level index block and a specific data index partition block need to be cached, and the top-level filter block, the specific filter partition block, the top-level index block, and the specific data index partition block may be sequentially accessed when read requests are processed. For example, when using the hierarchical structure, a relatively smaller amount of memory space is used for caching compared to the flat structure, but a remaining problem would be a number of accesses to the metadata block would be relatively higher (e.g., four times). In other words, the hierarchical structure may make information more effectively stored in memory space at a cost of more accesses.

In the method of managing metadata according to example embodiments, a sorted string table having a structure different from the conventional flat structure and the conventional hierarchical structure may be used. For example, the plurality of filter information and the plurality of data index information may be stored in the plurality of unified partition blocks, and at least one filter information and at least one data index information may be stored together in a single unified partition block. In other words, the filter information and the data index information may be managed in a unified manner. Additionally, the unified top-level block that stores the plurality of top-level index information for indexing the plurality of filter information and the plurality of data index information may be formed. In the sorted string table according to example embodiments, only the unified top-level block and a specific unified partition block need to be cached, and the unified top-level block and the specific unified partition block may be sequentially accessed when read requests are processed. Accordingly, a relatively smaller amount of memory space may be used for caching, the number of accesses to metadata block may be relatively less, and the metadata may be more efficiently managed, processed and/or treated.

FIG. 2 is a block diagram illustrating a storage device and a storage system including the storage device according to example embodiments.

Referring to FIG. 2, a storage system 100 includes a host device 200 and a storage device 300.

The host device 200 controls overall operations of the storage system 100. The host device 200 may include a host processor 210 and a host memory 220.

The host processor 210 may control an operation of the host device 200. For example, the host processor 210 may execute an operating system (OS). For example, the operating system may include a file system for file management and a device driver for controlling peripheral devices including the storage device 300 at the operating system level. The host memory 220 may store instructions and/or data that are executed and/or processed by the host processor 210. For example, the host memory 220 may include a volatile memory such as a dynamic random access memory (DRAM).

The storage device 300 is controlled and accessed by the host device 200. The storage device 300 may include a storage controller 310, a plurality of nonvolatile memories 320a, 320b, and 320c, and a buffer memory 330.

The storage controller 310 may control an operation of the storage device 300. For example, the storage controller 310 may control operations of the plurality of nonvolatile memories 320a, 320b, and 320c based on requests and data that are received from the host device 200.

The plurality of nonvolatile memories 320a, 320b, and 320c may be controlled by the storage controller 310, and may store a plurality of data. For example, the plurality of nonvolatile memories 320a, 320b, and 320c may store metadata, user data, and/or the like.

In some example embodiments, each of the plurality of nonvolatile memories 320a, 320b, and 320c may include a NAND flash memory. In other example embodiments, each of the plurality of nonvolatile memories 320a, 320b, and 320c may include one of an electrically erasable programmable read only memory (EEPROM), a phase-change random access memory (PRAM), a resistive random access memory (RRAM), a nano floating gate memory (NFGM), a polymer random access memory (PoRAM), a magnetic random access memory (MRAM), a ferroelectric random access memory (FRAM), and/or the like.

The buffer memory 330 may store instructions and/or data that are executed and/or processed by the storage controller 310, and may temporarily store data stored in or to be stored into the plurality of nonvolatile memories 320a, 320b, and 320c. For example, the buffer memory 330 may include a volatile memory such as a DRAM.

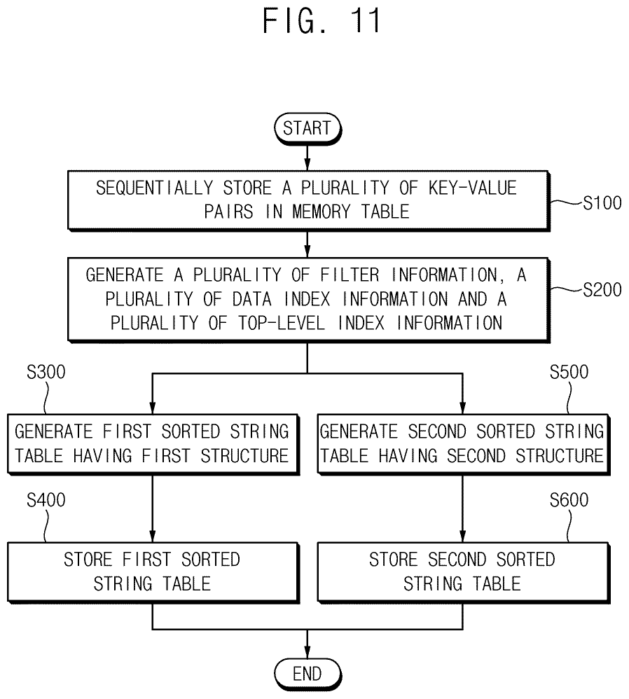

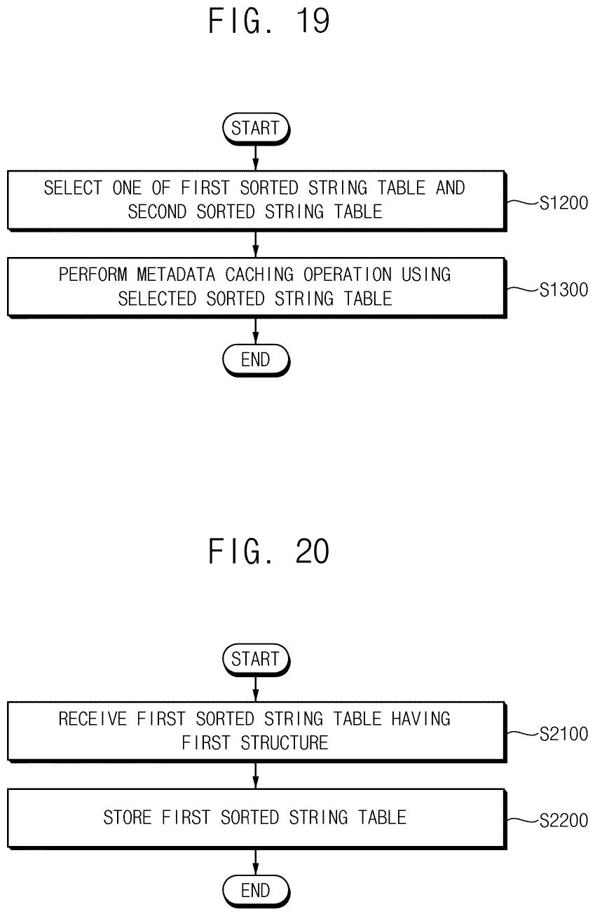

The storage controller 310 may include a metadata manager 312 to perform and/or control the method of managing metadata according to example embodiments described with reference to FIG. 1. For example, the host processor 210 may sequentially store a plurality of key-value pairs in a memory table of the host memory 220, may generate a plurality of filter information, a plurality of data index information and a plurality of upper-level index information that correspond to the plurality of key-value pairs, and may generate a first sorted string table having a first structure. The storage controller 310 and/or the metadata manager 312 may receive the first sorted string table and may store the first sorted string table in at least one of the plurality of nonvolatile memories 320a, 320b, and 320c. In addition, the storage controller 310 and/or the metadata manager 312 may perform a method of managing metadata according to example embodiments which will be described with reference to FIGS. 11, 14 and 19, and/or a method of operating a storage device according to example embodiments which will be described with reference to FIGS. 20, 21, and 22.

However, example embodiments are not limited thereto, and the metadata manager 312 may be located inside the storage device 300 and outside the storage controller 310, or may be located outside the storage device 300 (e.g., inside the host device 200). For example, when the metadata manager 312 is included in the host device 200, the host device 200 may perform the method of managing metadata according to example embodiments.

In some example embodiments, a layer structure of the host-storage devices may include an LSM-tree based key-value store layer, a user-level file system layer and a storage driver layer that correspond to the host device 200, and a storage layer that corresponds to the storage device 300.

In some example embodiments, the storage device 300 may be a solid state drive (SSD), a universal flash storage (UFS), a multimedia card (MMC) and/or an embedded multimedia card (eMMC). In other example embodiments, the storage device 300 may be one of a secure digital (SD) card, a micro SD card, a memory stick, a chip card, a universal serial bus (USB) card, a smart card, a compact flash (CF) card, and/or the like.

In some example embodiments, the storage device 300 may be connected to the host device 200 via a block accessible interface which may include, for example, a UFS, an eMMC, a nonvolatile memory express (NVMe) bus, a small computer small interface (SCSI) bus, a serial attached SCSI (SAS) bus, a universal serial bus (USB), a peripheral component interconnect (PCI) express (PCIe) bus, an advanced technology attachment (ATA) bus, a parallel ATA (PATA) bus, a serial ATA (SATA) bus, a compute express link (CXL) bus, and/or the like. The storage device 300 may use a block accessible address space corresponding to an access size of the plurality of nonvolatile memories 320a, 320b, and 320c to provide the block accessible interface to the host device 200, for allowing the access by units of a memory block with respect to data stored in the plurality of nonvolatile memories 320a, 320b, and 320c.

FIG. 3 is a diagram for describing a method of managing metadata according to example embodiments.

Referring to FIG. 3, an example of generating a memory tables MT, an immutable memory table IMT and sorted string tables SST00, SST01, SST02, SST10, SST11, SST12, SST20, SST21, SST22, . . . is illustrated.

A host memory may correspond to the host memory 220 in FIG. 2, and may correspond to the memory layer. A storage device may correspond to the storage device 300 in FIG. 2, and may correspond to the persistence layer.

The host memory (e.g., the memory layer) and the storage device (e.g., the persistence layer) may jointly maintain the data storage of key-value pairs. The LSM-tree may hierarchically manage sorted string tables in which key-value pairs are sorted with respect to key.

When key-value pairs are to be stored, the key-value pairs may be sequentially stored in the memory table MT of the host memory (e.g., an operation \textcircled{1} in FIG. 3). For example, the memory table MT may be included in or may be a part of host memory, and the key-value pairs may be stored in the form of a skiplist.

When a size (or data size) of the memory table MT reaches a predetermined (or, alternatively, desired or determined) first reference size, the memory table MT may be closed and may be converted into the immutable memory table IMT that can no longer be updated (e.g., an operation \textcircled{2} in FIG. 3).

Thereafter, other key-value pairs to be stored may be sequentially stored in another memory table, and when a size of the another memory table reaches the first reference size, the another memory table may be converted into another immutable memory table. In other words, the operations \textcircled{1} and \textcircled{2} may be repeated.

When the number of the immutable memory tables IMT reaches a reference number, e.g., when the size of used storage space of the host memory reaches a second reference size, the immutable memory tables IMT may be converted into sorted string tables, and the sorted string tables may be transmitted or flushed to the storage device (e.g., an operation \textcircled{3} in FIG. 3). The reference number, and other reference numbers herein, may be variously determined, selected, and/or desired values and may be further defined herein.

The transmitted sorted string tables may be stored hierarchically in the storage device. For example, the storage device may include a plurality of levels L0, L1, L2, . . . . The sorted string tables SST00, SST01, and SST02 that are transmitted at first may be stored in the first level L0 that is the lowest level.

Each of the plurality of levels L0, L1, and L2 may have a size limitation. For example, a size of the lower level (e.g., the first level L0) may be relatively smaller and a size of the upper level (e.g., the third level L2) may be relatively larger. In example embodiments, the size of the plurality of levels L0, L1, and L2 may increase as the level increases. However, example embodiments are not limited thereto and sizes may increase or decrease between levels.

When the number or size of the sorted string tables SST00, SST01, and SST02 that are stored in the first level L0 reaches a first threshold value, the sorted string tables SST00, SST01, and SST02 may be merged and sorted to generate the sorted string tables SST10, SST11, and SST12 of the second level L1 (e.g., an operation \textcircled{4} of FIG. 3). In addition, when the number or size of the sorted string tables SST10, SST11, and SST12 that are stored in the second level L1 reaches a second threshold value, the sorted string tables SST10, SST11, and SST12 may be merged and sorted to generate the sorted string tables SST20, SST21, and SST22 of the third level L2. In this manner, multiple levels of sorted string tables may be formed, and this merging process may be referred to as a compaction operation.

In the compaction operation, sorted string tables whose key-ranges overlap may be merged and sorted. Therefore, sorted string tables stored at each level (e.g., stored at the same level) may have non-overlapping key-ranges.

As the above-described operations are performed, the latest data may be stored in the host memory (e.g., the memory layer), and relatively newer data may be stored in a sorted string table at a lower level (e.g., the first level L0) of the storage device (e.g., the persistence layer).

In a read operation after the sorted string tables are stored in the storage device, when a read request for a specific key is received, a search may be sequentially performed from the first level L0, and a sorted string table including the requested key for each level may be determined to check whether the key exists.

A process of checking whether the key exists may include an operation of predicting (or forecasting) whether the key to be found exists using filter information stored in a sorted string table, an operation of reading data index information indicating a data block where the key may exist if the prediction result is true, and an operation of reading the data block indicated by the data index information to confirm whether the key exists. In the prediction result, there may be no true negative, and there may be false positive.

If the key does not exist (e.g., if the prediction result is false, or if the key does not actually exist in the data block), the next level of search may be performed. If the key actually exists, the found value may be returned and the search may be terminated.

The filter information and the index information may be metadata for solving read amplification, and may be frequently accessed when processing read requests. For key-value stores to achieve high throughput, it may be beneficial to cache frequently accessed metadata blocks. That is, caching frequently accessed metadata blocks may help achieving high throughput for key-value stores.

FIGS. 4A, 4B, 4C, 4D, 4E, and 4F are diagrams for describing a memory table and a first sorted string table that are generated by a method of managing metadata according to example embodiments.

Referring to FIG. 4A, in operation S100 of FIG. 1, a plurality of key-value pairs KV1, KV2, KV3, . . . may be stored in a memory table MT. For example, the first key-value pair KV1, the second key-value pair KV2, and the third key-value pair KV3 may be sorted with respect to key and may be sequentially stored in the memory table MT. Three key-value pairs are discussed in example embodiments, however, the disclosure is not limited thereto and greater or fewer key-value pairs (and associated values, e.g., top-level index information, filter information, data index information) may be used.

Referring to FIG. 4B, a first sorted string table SST_S1 having the first structure, which is generated in operation S300 of FIG. 1, may include one unified top-level block UTB, a plurality of unified partition blocks UPB1, UPB2, . . . , UPBn, and a plurality of data blocks DB1, DB2, . . . , DBm, where each of n and m is a positive integer greater than or equal to two.

For example, sizes of the plurality of unified partition blocks UPB1, UPB2, . . . , UPBn may all be the same. For example, sizes of the plurality of data blocks DB1, DB2, . . . , DBm may all be the same. In some example embodiment, the number (e.g., n) of the plurality of unified partition blocks UPB1, UPB2, . . . , UPBn and the number (e.g., m) of the plurality of data blocks DB1, DB2, . . . , DBm may be the same or different.

Referring to FIG. 4C, first top-level index information TI1, second top-level index information TI2, and third top-level index information TI3 may be sequentially stored in the unified top-level block UTB. The first top-level index information TI1 may correspond to the first key-value pair KV1 (e.g. may correspond to first filter information F1 and first data index information DI1), the second top-level index information TI2 may correspond to the second key-value pair KV2 (e.g. may correspond to second filter information F2 and second data index information DI2), and the third top-level index information TI3 may correspond to the third key-value pair KV3 (e.g. may correspond to third filter information F3 and third data index information DI3). For example, the top-level index information may be sorted with respect to key, and may be sequentially stored in the unified top-level block UTB.

Referring to FIG. 4D, first filter information F1, first data index information DI1, second filter information F2, second data index information DI2, third filter information F3 and third data index information DI3 may be sequentially stored in the first unified partition block UPB1. The first filter information F1 and the first data index information DI1 may correspond to the first key-value pair KV1, the second filter information F2 and the second data index information DI2 may correspond to the second key-value pair KV2, and the third filter information F3 and the third data index information DI3 may correspond to the third key-value pair KV3. For example, the filter information and the index information may be sorted with respect to key, and may be sequentially stored in the unified partition blocks. For example, the filter information and the index information may be accumulated in one unified partition block until the available storage space (or, for example, effective storage space or determined storage space) of the one unified partition block is insufficient.

Although FIG. 4D illustrates that three filter information F1, F2, and F3 and three data index information DI1, DI2, and DI3 are stored in one unified partition block UPB1, example embodiments are not limited thereto. For example, when the available storage space of the first unified partition block UPB1 is insufficient, the third filter information F3 and the third data index information DI3 may be stored in the second unified partition block UPB2. Although FIG. 4D illustrates that the storage space of the filter information F1, F2, and F3 and the storage space of the data index information DI1, DI2, and DI3 are separated, but example embodiments are not limited thereto. For example, the filter information F1, F2, and F3 and the data index information DI1, DI2, and DI3 may be alternately stored.

Referring to FIG. 4E, the first key-value pair KV1, the second key-value pair KV2, and the third key-value pair KV3 may be sequentially stored in the first data block DB1. For example, the key-value pairs may be sorted with respect to key, and may be sequentially stored in the data blocks. For example, the key-value pairs may be accumulated in one data block until the available storage space (or effective or valid storage space) of the one data block is insufficient.

Although FIG. 4E illustrates that three key-value pairs KV1, KV2, and KV3 are stored in one data block DB1, but example embodiments are not limited thereto. For example, when the available storage space of the first data block DB1 is insufficient, the third key-value pair KV3 may be stored in the second data block DB2.

Referring to FIG. 4F, an example of processing a read request using the first sorted string table SST_S1 having the first structure is illustrated.

For example, when the first key-value pair KV1 is to be read, the unified top-level block UTB may be accessed to check that the first top-level index information TI1 exists (e.g., an operation \textcircled{a} in FIG. 4F). Next, the first unified partition block UPB1 may be accessed based on the first top-level index information TI1, a prediction using the first filter information F1 may be performed, and it may be checked that the first data index DI1 exists if a result of the prediction is true (e.g., an operation \textcircled{b} in FIG. 4F). Thereafter, the first data block DB1 may be accessed based on the first data index DI1, it may be checked that the first key-value pair KV1 exists, and the first key-value pair KV1 may be read (an operation \textcircled{c} in FIG. 4F).

When using the conventional hierarchical structure, a relatively larger number of accesses to metadata block (e.g., four times) are used. In contrast, when using the first sorted string table SST_S1 having the first structure according to example embodiments, a relatively smaller number of accesses to metadata block (e.g., two times) may be used. In addition, when using the first sorted string table SST_S1 having the first structure according to example embodiments, only the unified top-level block UTB, the corresponding unified partition block (e.g., the unified partition block UPB1) and the corresponding data block (e.g., the data block DB1) need to be cached, and thus a relatively smaller amount of memory space may be used for caching. For example, according to some example embodiments, there may be an increase in reliability, operating parameters (e.g., temperature resilience), speed, accuracy, and/or power efficiency of the storage device based on the above methods. Therefore, the improved devices and methods overcome the deficiencies of the conventional devices and methods while reducing resource consumption, and/or improving data accuracy, operating parameters, and resource allocation (e.g., latency and storage). Further, there is an improvement in user experience in the device by providing the improved process.

To distinguish from the conventional hierarchical structure, the first sorted string table SST_S1 having the first structure according to example embodiments may be referred to as a unified hierarchical structure.

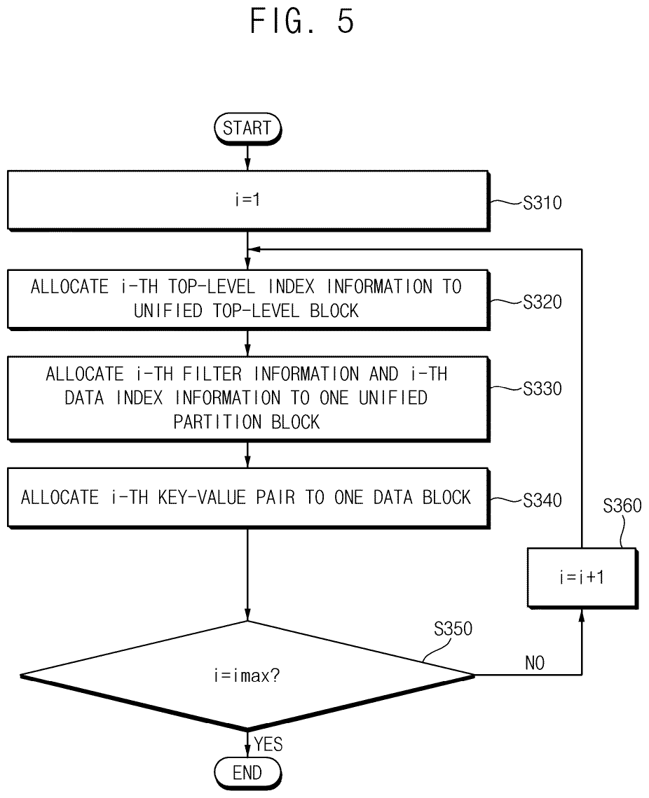

FIG. 5 is a flowchart illustrating an example of generating a first sorted string table in FIG. 1.

Referring to FIGS. 1, 4A, 4B, 4C, 4D, 4E, and 5, when generating the first sorted string table (operation S300), the plurality of key-value pairs and related information stored in the memory table may be sequentially allocated and stored.

For example, i may be set to one at the beginning of the operation, where i is a positive integer (operation S310).

For example, i-th top-level index information may be allocated (or assigned) to the unified top-level block UTB (operation S320). For example, the first top-level index information TI1 corresponding to the first key-value pair KV1 may be allocated to and stored in the unified top-level block UTB, and the second top-level index information TI2 corresponding to the second key-value pair KV2 may be allocated to and stored in the unified top-level block UTB.

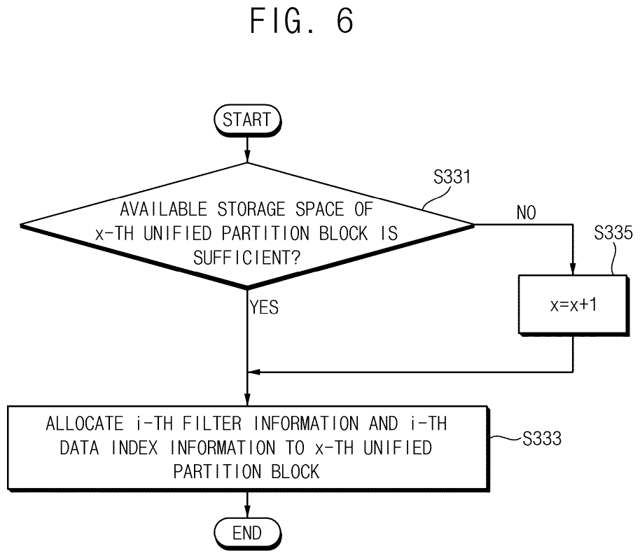

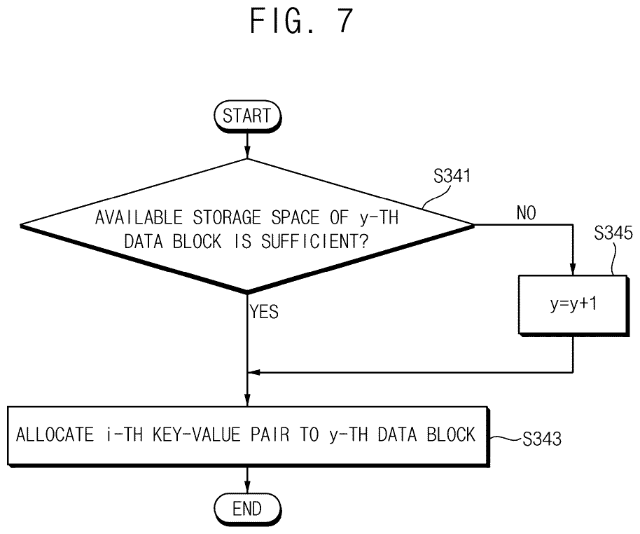

For example, i-th filter information and i-th data index information may be allocated to one of the plurality of unified partition blocks UPB1, UPB2, . . . , UPBn (operation S330), and i-th key-value pair may be allocated to one of the plurality of data blocks DB1, DB2, . . . , DBm (operation S340). Operations S330 and S340 will be described in detail with reference to FIGS. 6 and 7.

Thereafter, when i is less than imax (operation S350: NO), i may be increased by one (operation S360), and operations S320, S330, and S340 may be repeated. When i is equal to imax (operation S350: YES), the process may be terminated. For example, imax may be equal to the number of the plurality of key-value pairs stored in the memory table, and operations S320, S330, and S340 may be performed for all of the plurality of key-value pairs.

FIG. 6 is a flowchart illustrating an example of allocating i-th filter information and i-th data index information in FIG. 5.

Referring to FIGS. 5 and 6, when allocating the i-th filter information and the i-th data index information (operation S330), x may be set to one at the beginning of the operation (e.g., at operation S310), where x is a positive integer.

When an available storage space of an x-th unified partition block is sufficient (operation S331: YES), the i-th filter information and the i-th data index information may be allocated to the x-th unified partition block (operation S333). In other words, the i-th filter information and the i-th data index information may be allocated to and stored in a present (or current) unified partition block.

When the available storage space of the x-th unified partition block is insufficient (operation S331: NO), x may be increased by one (operation S335), and operation S333 may be performed. In other words, the i-th filter information and the i-th data index information may be allocated to and stored in a next (e.g., subsequent) unified partition block.

For example, the first filter information F1 and the first data index information DI1, which correspond to the first key-value pair KV1 among the plurality of key-value pairs, may be allocated to and stored in the first unified partition block UPB1.

For example, the second filter information F2 and the second data index information DI2, which correspond to the second key-value pair KV2 subsequent to the first key-value pair KV1 among the plurality of key-value pairs, may be allocated to and stored in the first unified partition block UPB1 or the second unified partition block UPB2 subsequent to the first unified partition block UPB1.

For example, when an available storage space of the first unified partition block UPB1 is sufficient to store the second filter information F2 and the second data index information DI2, e.g., when a size of remaining space of the first unified partition block UPB1 after the first filter information F1 and the first data index information DI1 are stored is greater than or equal to sizes of the second filter information F2 and the second data index information D12, the second filter information F2 and the second data index information DI2 may be allocated to and stored in the first unified partition block UPB1. For example, when the available storage space of the first unified partition block UPB1 is insufficient to store the second filter information F2 and the second data index information DI2, e.g., when the size of the remaining space of the first unified partition block UPB1 is smaller than the sizes of the second filter information F2 and the second data index information DI2, the second filter information F2 and the second data index information DI2 may be allocated to and stored in the second unified partition block UPB2.

FIG. 7 is a flowchart illustrating an example of allocating i-th key-value pair in FIG. 5.

Referring to FIGS. 5 and 7, when allocating the i-th key-value pair (operation S340), y may be set to one at the beginning of the operation (e.g., at operation S310), where y is a positive integer.

When an available storage space of an y-th data block is sufficient (operation S341: YES), the i-th key-value pair may be allocated to the y-th data block (operation S343). In other words, the i-th key-value pair may be allocated to and stored in a present data block.

When the available storage space of the y-th data block is insufficient (operation S341: NO), y may be increased by one (operation S345), and operation S343 may be performed. In other words, the i-th key-value pair may be allocated to and stored in a next data block.

For example, the first key-value pair KV1 among the plurality of key-value pairs may be allocated to and stored in the first data block DB1.

For example, the second key-value pair KV2 subsequent to the first key-value pair KV1 among the plurality of key-value pairs may be allocated to and stored in the first data block DB1 or the second data block DB2 subsequent to the first data block DB1.

For example, when an available storage space of the first data block DB1 is sufficient to store the second key-value pair KV2, the second key-value pair KV2 may be allocated to and stored in the first data block DB1. For example, when the available storage space of the first data block DB1 is insufficient to store the second key-value pair KV2, the second key-value pair KV2 may be allocated to and stored in the second data block DB2.

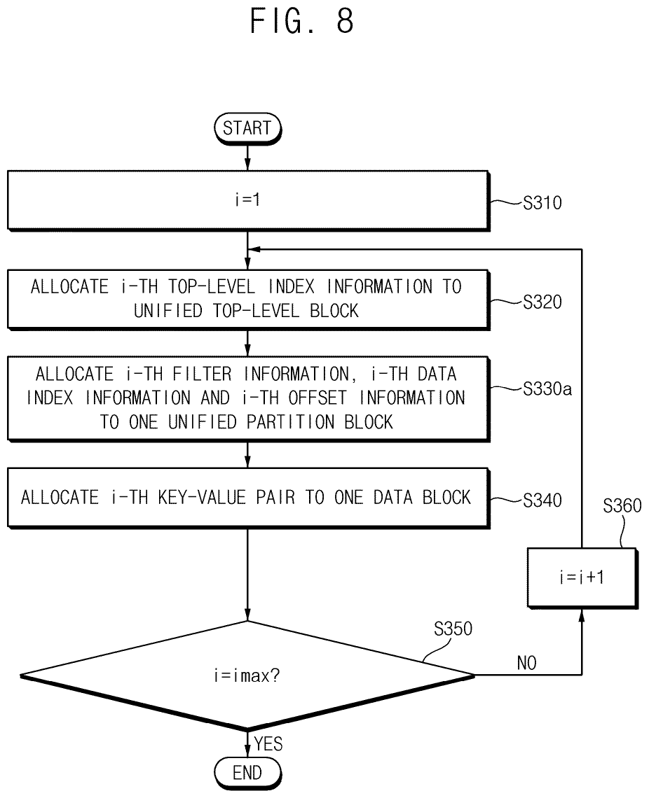

FIG. 8 is a flowchart illustrating an example of generating a first sorted string table in FIG. 1. The descriptions repeated with or overlapping with descriptions of FIG. 5 will be omitted in the interest of brevity.

Referring to FIGS. 1, and 8, when generating the first sorted string table (operation S300), operations S310, S320, S340, S350, and S360 may be the same or substantially the same as those described with reference to FIG. 5.

The i-th filter information, the i-th data index information, and i-th offset information may be allocated to one of the plurality of unified partition blocks UPB1, UPB2, . . . , UPBn (operation S330a). For example, the i-th offset information may include information for identifying the i-th filter information and the i-th data index information. For example, the i-th offset information may correspond to the i-th filter information, and may represent a size of the filter.

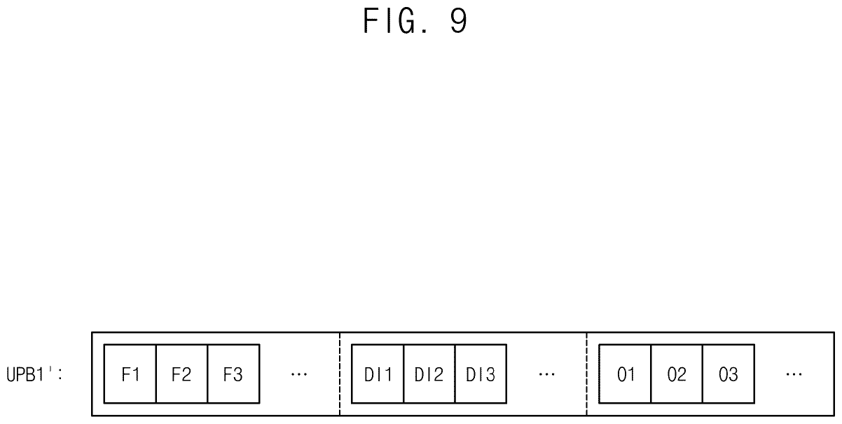

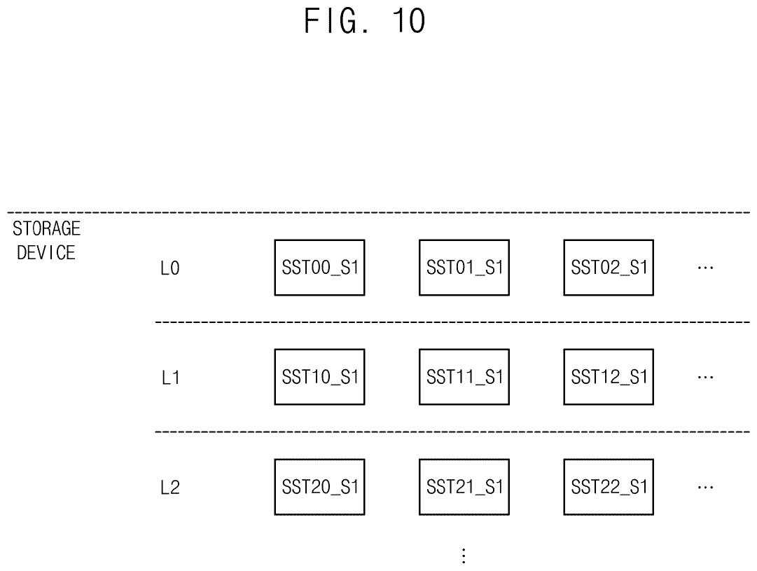

FIG. 9 is a diagram for describing a first sorted string table generated by a method of managing metadata according to example embodiments. The descriptions repeated with or overlapping with descriptions of FIG. 4D will be omitted in the interest of brevity.

Referring to FIG. 9, first filter information F1, first data index information DI1, first offset information O1, second filter information F2, second data index information DI2, second offset information O2, third filter information F3, third data index information DI3 and third offset information O3 may be sequentially stored in a first unified partition block UPB1′. The first offset information O1 may correspond to the first key-value pair KV1 (e.g. may correspond to first filter information F1), the second offset information O2 may correspond to the second key-value pair KV2 (e.g. may correspond to second filter information F2), and the third offset information O3 may correspond to the third key-value pair KV3 (e.g. may correspond to third filter information F3). For example, the offset information O1, O2, and O3 may be stored at the end of the first unified partition block UPB1′.

Sizes of filter information and data index information may be different for each key-value pair. To read filter information and data index information from a unified partition block, an offset for identifying the filter information and the data index information may be used. Therefore, offset information (e.g., the size of the filter) corresponding to each filter information and each data index information may be stored together.

FIG. 10 is a diagram for describing a method of managing metadata according to example embodiments. The descriptions repeated with or overlapping with descriptions of FIG. 3 will be omitted in the interest of brevity.

Referring to FIG. 10, an example of generating a plurality of sorted string tables SST00_S1, SST01_S1, SST02_S1, SST10_S1, SST11_S1, SST12_S1, SST20_S1, SST21_S1, SST22_S1, . . . having the first structure according to example embodiments is illustrated, and an example of storing the plurality of sorted string tables SST00_S1, SST01_S1, SST02_S1, SST10_S1, SST11_S1, SST12_S1, SST20_S1, SST21_S1, SST22_S1, . . . in the storage device is illustrated. For example, each sorted string table may be generated and implemented as described with reference to FIG. 1 and FIGS. 4A through 9, and the sorted string tables may be hierarchically stored in the storage device as described with reference to FIG. 3.

FIG. 11 is a flowchart illustrating a method of managing metadata according to example embodiments. The descriptions repeated with or overlapping with descriptions of FIG. 1 will be omitted in the interest of brevity.

Referring to FIG. 11, in a method of managing metadata according to example embodiments, operations S100, S200, S300, and S400 may be the same or substantially the same as those described with reference to FIG. 1.

A second sorted string table having a second structure different from the first structure is generated such that the plurality of filter information are included in a filter block, the plurality of data index information are included in a data index block, and the plurality of key-value pairs are included in a plurality of data blocks (operation S500). The second sorted string table is stored (operation S600). For example, as with the first sorted string table, the second sorted string table may be stored in at least one nonvolatile memory included in the storage device.

In some example embodiments, operations S300 and S400 may be simultaneously or substantially simultaneously performed, and operations S500 and S600 may be simultaneously or substantially simultaneously performed. However, example embodiments are not limited thereto.

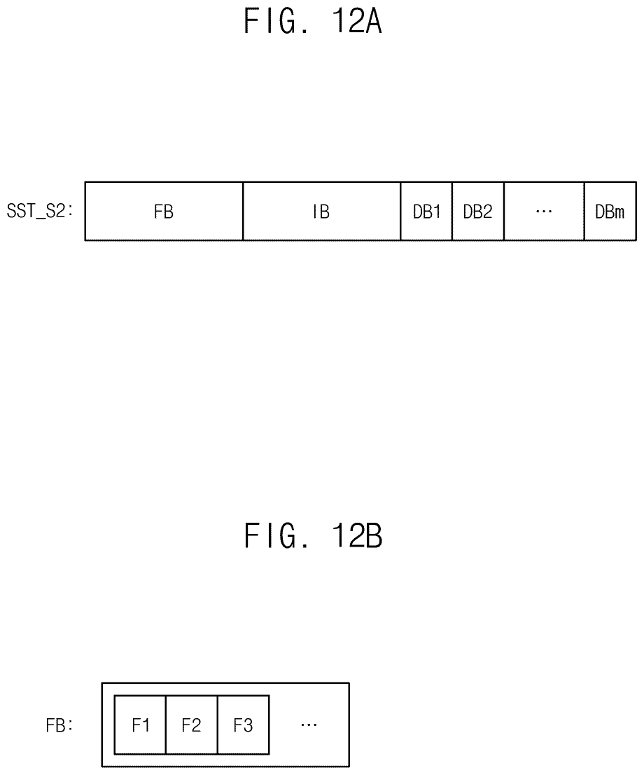

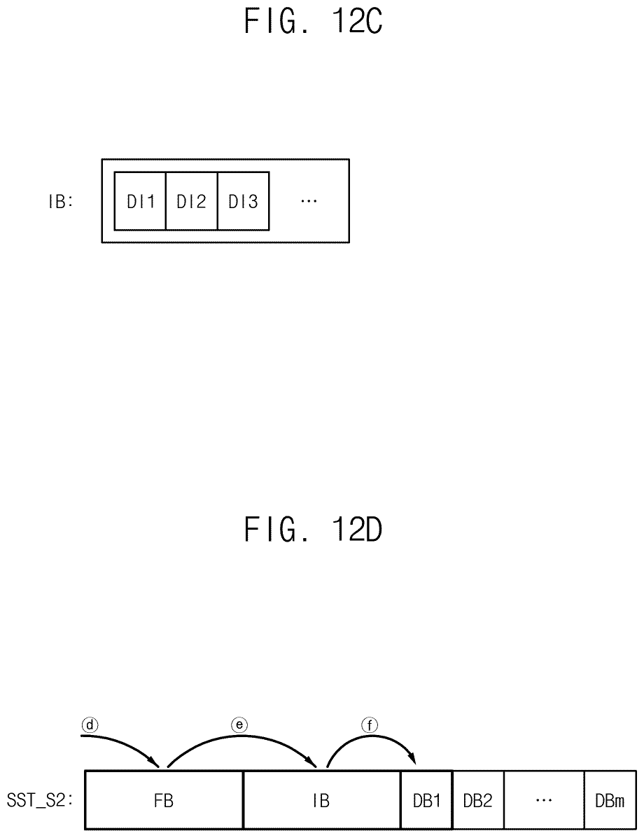

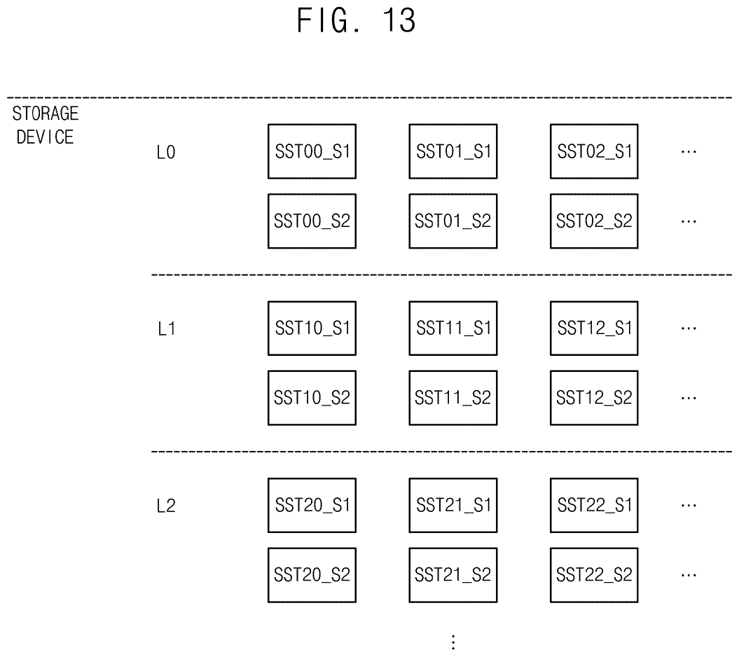

FIGS. 12A, 12B, 12C and 12D are diagrams for describing a second sorted string table generated by a method of managing metadata according to example embodiments. The descriptions repeated with or overlapping with descriptions of FIGS. 4A, 4B, 4C, 4D, 4E, and 4F will be omitted in the interest of brevity.

Referring to FIG. 12A, a second sorted string table SST_S2 having the second structure, which is generated in operation S500 of FIG. 11, may include one filter block FB, one data index block IB, and a plurality of data blocks DB1, DB2, . . . , DBm.

Referring to FIG. 12B, the first filter information F1 corresponding to the first key-value pair KV1, the second filter information F2 corresponding to the second key-value pair KV2, and the third filter information F3 corresponding to the third key-value pair KV3 may be sequentially stored in the filter block FB.

Referring to FIG. 12C, the first data index information DI1 corresponding to the first key-value pair KV1, the second data index information DI2 corresponding to the second key-value pair KV2, and the third data index information DI3 corresponding to the third key-value pair KV3 may be sequentially stored in the data index block IB.

Although not illustrated in detail, a configuration of the plurality of data blocks DB1, DB2, . . . , DBm may be the same or substantially the same as that described with reference to FIG. 4E.

The plurality of top-level index information TI1, TI2, and TI3 may not be stored in the second sorted string table SST_S2 having the second structure.

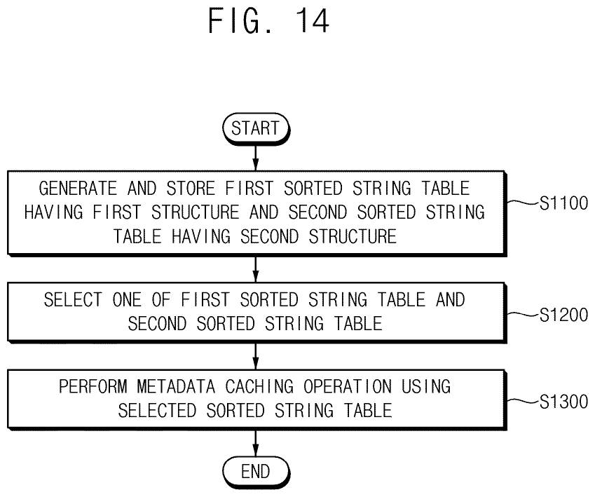

In some example embodiments, the filter information F1, F2, and F3, the data index information DI1, DI2, and DI3 and the key-value pairs KV1, KV2, and KV3 that are stored in the second sorted string table SST_S2 having the second structure and the filter information F1, F2, and F3, the data index information DI1, DI2, and DI3 and the key-value pairs KV1, KV2, and KV3 that are stored in the first sorted string table SST_S1 having the first structure may be the same as each other. In other words, two sorted string tables having different structures may be generated and stored using the same metadata and the same key-value pairs. As will be described with reference to FIG. 14, one of the two sorted string tables including the same data may be dynamically and/or adaptively selected to perform a metadata caching operation.

Referring to FIG. 12D, an example of processing a read request using the second sorted string table SST_S2 having the second structure is illustrated.

For example, when the first key-value pair KV1 is to be read, the filter block FB may be accessed to perform a prediction using the first filter information F1 (e.g., an operation \textcircled{d} of FIG. 12D), and the data index block IB may be accessed to check that the first data index DI1 exists if a result of the prediction is true (e.g., an operation \textcircled{e} in FIG. 12D). Thereafter, the first data block DB1 may be accessed based on the first data index DI1, it may be checked that the first key-value pair KV1 exists, and the first key-value pair KV1 may be read (an operation \textcircled{f} in FIG. 12D).

When using the second sorted string table SST_S2 having the second structure, a relatively smaller number of accesses to metadata block (e.g., two times) may be used. However, the entire filter block FB, the entire data index block IB, and all data blocks DB1, DB2, . . . , DBm should be cached, and thus a relatively larger amount of memory space may be used for caching.

The second structure of the second sorted string table SST_S2 may be the same or substantially the same as the conventional flat structure.

FIG. 13 is a diagram for describing a method of managing metadata according to example embodiments. The descriptions repeated with or overlapping with descriptions of FIGS. 3 and 10 will be omitted in the interest of brevity.

Referring to FIG. 13, an example of generating and storing the plurality of sorted string tables SST00_S1, SST01_S1, SST02_S1, SST10_S1, SST11_S1, SST12_S1, SST20_S1, SST21_S1, SST22_S1, . . . having the first structure according to example embodiments is illustrated, and an example of generating and storing a plurality of sorted string tables SST00_S2, SST01_S2, SST02_S2, SST10_S2, SST11_S2, SST12_S2, SST20_S2, SST21_S2, SST22_S2, . . . having the second structure according to example embodiments is illustrated.

FIG. 14 is a flowchart illustrating a method of managing metadata according to example embodiments.

Referring to FIG. 14, in a method of managing metadata according to example embodiments, a first sorted string table having a first structure and a second sorted string table having a second structure are generated and stored (operation S1100). Operation S1100 may include operations S100, S200, S300, S400, S500, and S600 described with reference to FIGS. 1 through 13.

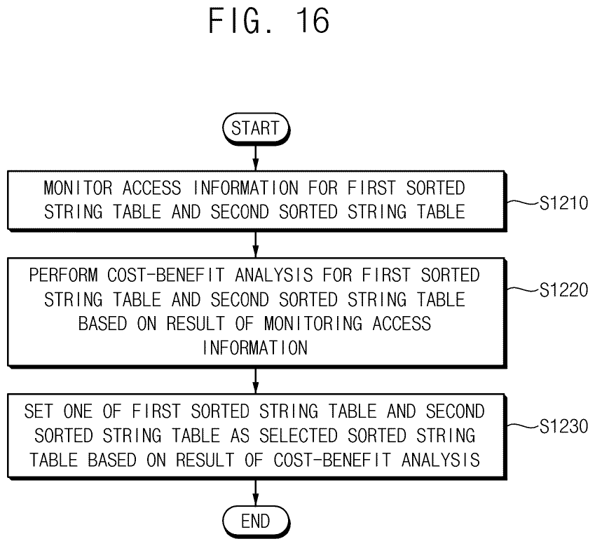

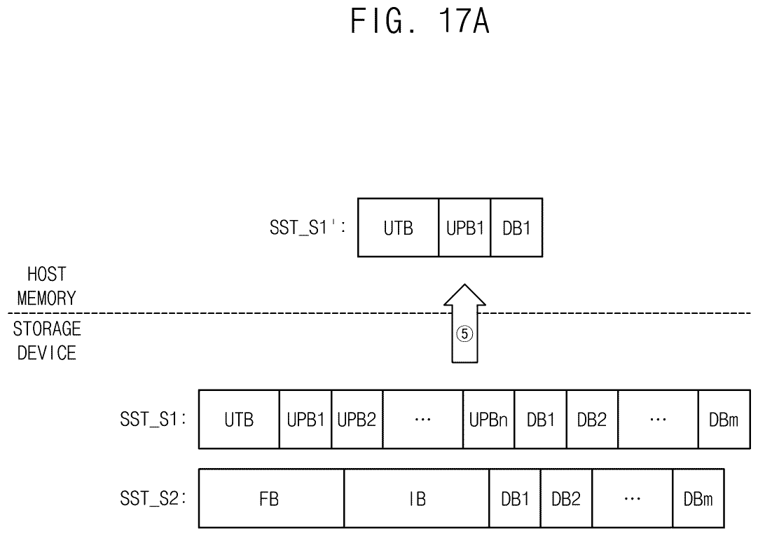

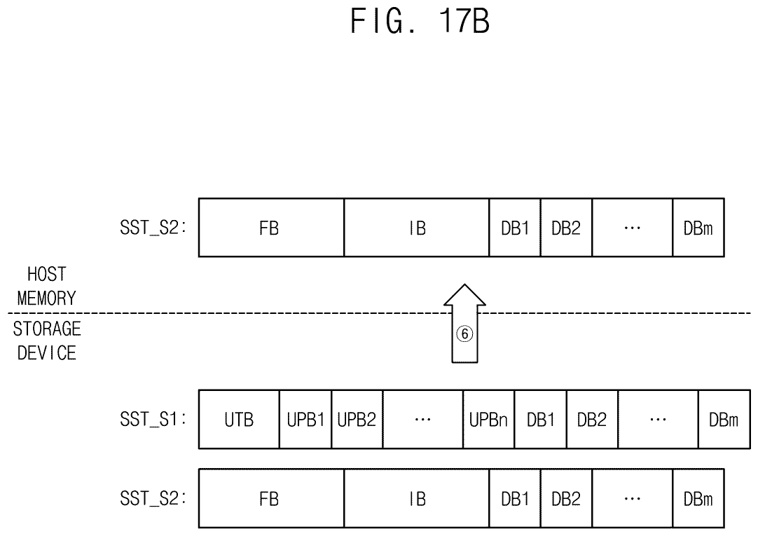

One of the first sorted string table and the second sorted string table is selected (operation S1200). A metadata caching operation is performed using a selected sorted string table (operation S1300). Operation S1200 will be described with reference to FIG. 16, and operation S1300 will be described with reference to FIG. 17. In example embodiments, the selected sorted string table may be changed during operations of the storage device, for example, based on the cost-benefit analysis changing, as discussed further below.

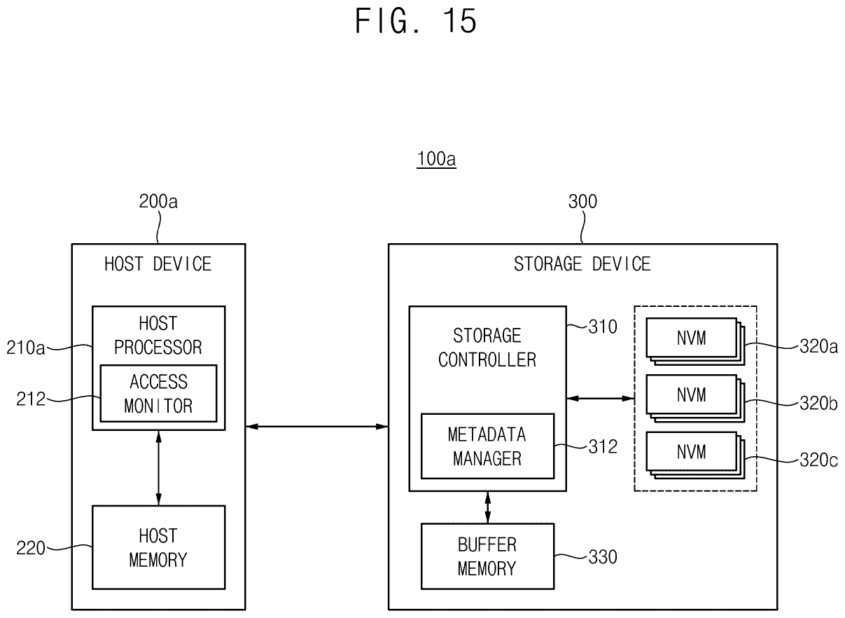

FIG. 15 is a block diagram illustrating a storage device and a storage system including the storage device according to example embodiments. The descriptions repeated with or overlapping with descriptions of FIG. 2 will be omitted in the interest of brevity.

Referring to FIG. 15, a storage system 100a includes a host device 200a and a storage device 300. The host device 200a may include a host processor 210a and a host memory 220. The storage device 300 may include a storage controller 310, a plurality of nonvolatile memories 320a, 320b, and 320c, and a buffer memory 330.

The storage system 100a may be the same or substantially the same as the storage system 100 of FIG. 2, except that the host processor 210a includes an access monitor 212.

The access monitor 212 and the metadata manager 312 may perform the method of managing metadata according to example embodiments described with reference to FIG. 14. For example, the metadata manager 312 may receive and store a first sorted string table and a second sorted string table. For example, the access monitor 212 and the metadata manager 312 may select one of the first sorted string table and the second sorted string table. A selected sorted string table may be transmitted from the storage device 300 to the host device 200a, and may be cached in the host memory 220.

However, example embodiments are not limited thereto, and the access monitor 212 may be located inside the host device 200a and outside the host processor 210a, or may be located outside the host device 200a (e.g., inside the storage device 300).

FIG. 16 is a flowchart illustrating an example of selecting one of a first sorted string table and a second sorted string table in FIG. 14.

Referring to FIGS. 14 and 16, when selecting one of the first sorted string table and the second sorted string table (operation S1200), access information for the first sorted string table and the second sorted string table may be monitored when read requests are processed (operation S1210). A cost-benefit analysis for the first sorted string table and the second sorted string table may be performed based on a result of monitoring the access information (operation S1220). One of the first sorted string table and the second sorted string table may be set as the selected sorted string table based on a result of the cost-benefit analysis (operation S1230). For example, operation S1210 may be performed by the access monitor 212 in FIG. 15, and operations S1220 and S1230 may be performed by the metadata manager 312 in FIG. 15.

In some example embodiments, the cost-benefit analysis may be performed based on a change in time for processing the read requests. For example, one of the first sorted string table and the second sorted string table may be selected such that the time for processing the read requests is reduced.

In some example embodiments, the result of monitoring the access information may include access time information when cache hits and cache misses occur, cache miss rate information, and utilization ratio information of the first sorted string table and the second sorted string table.

In some example embodiments, when a size of an available storage space for the metadata caching operation is greater than a reference size, the second sorted string table may be selected. When the size of the available storage space for the metadata caching operation is less than or equal to the reference size, the first sorted string table may be selected.

In some example embodiments, when an access frequency for the plurality of key-value pairs is greater than a reference frequency, e.g., the number of accesses to the plurality of key-value pairs is greater than a reference number, the second sorted string table may be selected. When the access frequency for the plurality of key-value pairs is less than or equal to the reference frequency, e.g., when the number of accesses to the plurality of key-value pairs is less than or equal to the reference number, the first sorted string table may be selected.

Conventionally, a sorted string table with a single structure was used. In contrast, according to example embodiments, sorted string tables with different structures may be stored and used, and one metadata structure for each sorted string table may be determined adaptively and dynamically. Thereby, the storage device may be improved.

In operation S1210, access information for each sorted string table may be monitored, and information necessary to determine which metadata structure to select for each sorted string table, such as access frequency, cache miss rate, and/or the like, may be provided as a result of monitoring the access information.

In operation S1220, periodic cost-benefit analysis may be performed for each sorted string table based on the information provided as the result of monitoring the access information. Based on a result of the cost-benefit analysis, a metadata structure for improving or enhancing performance may be selected and determined.

To adaptively and dynamically change the metadata structure for each sorted string table based on the cost-benefit analysis, both the sorted string table having the first structure (e.g., the unified hierarchical structure) and the sorted string table of the second structure (e.g., the flat structure) should be stored. Therefore, both the sorted string table having the first structure and the sorted string table of the second structure may be generated and stored by the flush and compaction operations.

In some example embodiments, the cost-benefit analysis may be performed based on the change in an average time for processing read requests, and the average time for processing the read requests may be obtained based on Equation 1.

$${T}_{get} = {nT}_{f} + {T}_{i} + {T}_{d} ( n \geq 1 ) \qquad [ Equation 1 ]$$

In Equation 1, T_{get} denotes the average time for processing the read requests, T_{f}, Tᵢ, and T_{d} denote average time used to read the filter block, the data index block, and the data block, respectively, and n denotes the average number of searching sorted string tables when the read requests are processed.

With respect to nT_{f}, the filter block may be read during the search process of all sorted string tables. With respect to Tᵢ and T_{d}, the data index block and the data block may be read only from the sorted string tables where it is predicted to exist desired data using the filter.

An average access time of any block (e.g., the filter block, the data index block and/or the data block) may be determined by whether each block is cached in the host memory and the metadata structure of the sorted string table corresponding thereto. For example, T_{f} and Tᵢ may be obtained based on Equation 2 and Equation 3.

$${T}_{f} = {xT}_{Ff} + ( 1 - x ) ( {T}_{Ht} + {T}_{Hf} ) \qquad [ Equation 2 ]$$

$${T}_{i} = {yT}_{Fi} + ( 1 - y ) {T}_{Hi} \qquad [ Equation 3 ]$$

In Equation 2 and Equation 3, T_{Ab} denotes an average time used to read ‘b’ block when using ‘A’ metadata structure. For example, in T_{Ab}, ‘A’ may be ‘F’ or ‘H’, and ‘b’ may be ‘f’, ‘i’ or ‘t’. With respect to the metadata structure, ‘F’ denotes the flat structure or the second structure, and ‘H’ denotes the unified hierarchical structure or the first structure. The flat structure may also be referred to as a flat metadata structure or simply F-meta structure, and the unified hierarchical structure may also be referred to as a unified hierarchical metadata structure or simply H-meta structure. With respect to the block, ‘f’ denotes the filter block, ‘i’ denotes the data index block, and ‘t’ denotes the unified top-level block included in the unified hierarchical structure. For example, T_{Ff} may represent an average time used to read the filter block when using the flat structure (e.g., the F-meta structure). In addition, x denotes a ratio of accesses through the flat structure (e.g., the F-meta structure) among all accesses to the filter block, and y denotes a ratio of accesses through the flat structure (e.g., the F-meta structure) among all accesses to the data index block. In Equation 2, the average time (e.g., T_{Ht}) to read the unified top-level block may be included. In contrast, in Equation 3, the average time (e.g., T_{Ht}) to read the unified top-level block may be excluded because the unified top-level block is accessed once and such access is preceded.

The average access time (e.g., T_{Ff}, T_{Fi}, T_{Ht}, T_{Hf}, T_{Hi}, and T_{d}) of all blocks may be determined by whether each block is cached, and may be obtained based on Equation 4.

$${T}_{b} = {T}_{b}^{hit} + {m}_{b} \times {T}_{b}^{miss} \qquad [ Equation 4 ]$$

Equation 4 may represent the average access time of each block. For example, in Equation 4, ‘b’ may be ‘Ff’, ‘Fi’, ‘Ht’, ‘Hf’, ‘Hi’, or ‘d’. In addition, m_{b} denotes a cache miss rate of the corresponding block,

$${T}_{b}^{hit}$$

denote an average access time when a cache hit occurs on the corresponding block, and

$${T}_{b}^{miss}$$

denote an average access time when a cache miss occurs on the corresponding block.

When monitoring the access information in operation S1210, the access time

$$( e . g . , {T}_{b}^{hit} and {T}_{b}^{miss} )$$

of each block when the cache hit and the cache miss occur, the cache miss rate (e.g., m_{b}), the utilization ratio (e.g., x and y) of the filter block and the data index block when using the flat structure (e.g., the F-meta structure), the average number (e.g., n) of sorted string tables accessed until the key is found, etc. may be predicted, calculated, and/or managed. Thereafter, based on such values managed based on the prediction and/or calculation by monitoring, it may be determined whether to change the metadata structure for each sorted string table. For example, the metadata structure for each sorted string table may be selectively changed by the cost-benefit analysis based on the amount of change in the average time for processing the read requests T_{get}.

In some example embodiments, when monitoring the access information, n, x, and y may be obtained based on the average values calculated by monitoring, rather than the prediction.

For example, n may be the average number of searching sorted string tables, which may not be affected by changes in the metadata structure. Therefore, the actual number of sorted string tables accessed when the read requests are processed may be monitored, and the actual average value may be used for the cost-benefit analysis.

For example, x and y may be the access ratio of filters and the access ratio of data indexes when using the flat structure (e.g., the F-meta structure), respectively. Therefore, x and y may be calculated based on the total number of accesses to the filters and the data indexes and the access information of filters and data indexes of a specific sorted string table.

For example, the changes in x and y may be calculated based on Equation 5.

$${x}^{′} = x \pm {f}_{target} , {y}^{′} = y \pm {i}_{target} ( + : H 2 F , - : F 2 H ) \qquad [ Equation 5 ]$$

In Equation 5, x′ and y′ denote the changes in x and y, respectively, and f_{target} and i_{target} denote the access ratio of filter blocks and the access ratio of data index blocks of a target sorted string table, respectively. The effect (e.g. a sign + or −) of the access ratios may be determined by the metadata structure of the target sorted string table. For example, when the metadata structure of the target sorted string table is the unified hierarchical structure (e.g., the H-meta structure), and when the metadata structure is changed from the unified hierarchical structure to the flat structure (e.g., the F-meta structure), e.g., in H2F case, x′ and y′ may be calculated by adding the access ratios f_{target} and i_{target}. For example, when the metadata structure of the target sorted string table is the flat structure (e.g., the F-meta structure), and when the metadata structure is changed from the flat structure to the unified hierarchical structure (e.g., the H-meta structure), e.g., in F2H case, x′ and y′ may be calculated by subtracting the access ratios f_{target} and i_{target}.

In some example embodiments, the change in cache miss rate for each block may be obtained based on the prediction.

The operation of changing the metadata structure of the sorted string table may cause the following changes in the cache miss rate.

First, the average cache miss rate may change due to the eviction of previously cached metadata blocks. For example, when the metadata structure is changed from the unified hierarchical structure to the flat structure, e.g., in H2F case, the unified top-level blocks and the unified partition blocks of the previously cached unified hierarchical structure (e.g., the H-meta structure) may be evicted, thereby changing the average cache miss rate of the unified hierarchical structure (e.g., the H-meta structure).

Second, the average cache miss rate may change due to the newly cached metadata blocks. For example, when the metadata structure is changed from the unified hierarchical structure to the flat structure, e.g., in H2F case, the average cache miss rate of the flat structure (e.g., the F-meta structure) may change due to the filter blocks and the data index blocks of the newly cached flat structure (e.g., the F-meta structure).

In some example embodiments, when predicting the changes in cache miss rates due to the changes in metadata structures, history-based prediction may be performed. For example, the history-based prediction may be performed based on Equation 6.

$${m}_{b}^{′} = {m}_{b} \pm Δ {m}_{b} ( + : same direction , - : diff . direction ) \qquad [ Equation 6 ]$$

The history-based prediction may include some assumptions. First, it may be assumed that the change in cache miss rate (e.g., Δm_{b}) is the same as the change in the previous metadata structure change. Second, the effect (e.g., a sign + or −) of the change in cache miss rate may be determined by whether it is the same change as the previous metadata structure change. For example, when the previous metadata structure change was H2F case, and when the change by H2F case is predicted now, Δm_{b} may be added, and when the change by F2H case is predicted now, Δm_{b} may be subtracted.

As a result, the metadata manager 312 may periodically or aperiodically determine whether to change the metadata structure of each sorted string table based on the information collected by the access monitor 212, and may change the sorted string tables at once that provide the greatest benefit when changed.

In some example embodiments, sorted string tables that are initially generated by flush operation may not have access counts and may therefore not affected by caching. Thus, the initially generated sorted string tables may be initially set, selected and/or cached as the flat structure (e.g., the F-meta structure).

In some example embodiments, sorted string tables that are generated by the compaction operation may follow (or inherit) a structure that has a larger proportion of metadata structures of sorted string tables being merged. For example, when the flat structure (e.g., the F-meta structure) has a larger proportion of compaction target sorted string tables, all newly generated sorted string tables may be set, selected and/or cached as the flat structure (e.g., the F-meta structure).

In the method of managing metadata according to example embodiments, both the conventional flat structure and the new unified hierarchical structure may be used together, and the metadata structure for each sorted string table may be dynamically and/or adaptively determined by the cost-benefit analysis based on monitoring the access information for each sorted string table. Accordingly, the metadata may be more efficiently managed.

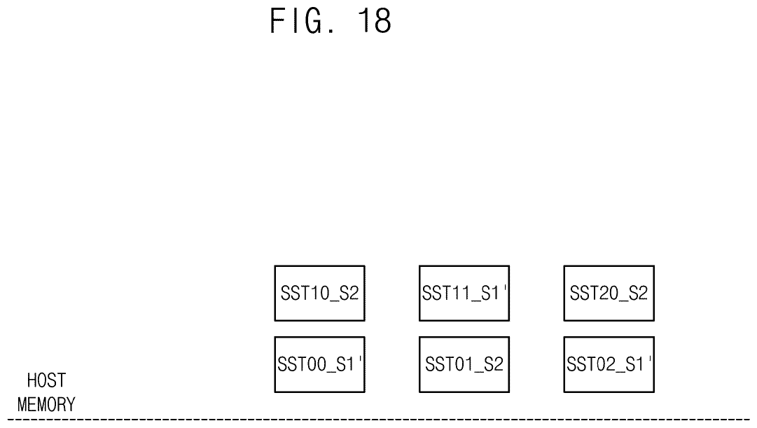

FIGS. 17A, 17B, and 18 are diagrams for describing a metadata caching operation in FIG. 14.

Referring to FIG. 17A, when the first sorted string table SST_S1 having the first structure is selected, a portion or part of the first sorted string table SST_S1 may be cached to an available storage space (e.g., the host memory) for the metadata caching operation (e.g., an operation \textcircled{5} of FIG. 17A). For example, a first partial sorted string table SST_S1′ that includes the unified top-level block UTB, the first unified partition block UPB1 and the first data block DB1 may be cached.

Referring to FIG. 17B, when the second sorted string table SST_S2 having the second structure is selected, the entire of the second sorted string table SST_S2 may be cached to the available storage space (e.g., the host memory) for the metadata caching operation (e.g., an operation \textcircled{6} of FIG. 17B).

Referring to FIG. 18, after generating and storing the plurality of sorted string tables SST00_S1, SST01_S1, SST02_S1, SST10_S1, SST11_S1, SST12_S1, SST20_S1, SST21_S1, SST22_S1, . . . having the first structure and plurality of sorted string tables SST00_S2, SST01_S2, SST02_S2, SST10_S2, SST11_S2, SST12_S2, SST20_S2, SST21_S2, SST22_S2, . . . having the second structure as illustrated in FIG. 13, partial sorted string tables SST00′S1′, SST02′S1′ and SST11′S1′ having the selected first structure and the sorted string tables SST01_S2, SST10_S2, and SST20_S2 having the second structure, which are selected by performing the above-described monitoring and cost-benefit analysis, may be cached to the host memory. However, example embodiments are not limited thereto.

FIG. 19 is a flowchart illustrating a method of managing metadata according to example embodiments. The descriptions repeated with or overlapping with descriptions of FIG. 14 will be omitted in the interest of brevity.

Referring to FIG. 19, in a method of managing metadata according to example embodiments, operations S1200 and S1300 may be the same or substantially the same as those described with reference to FIG. 14. An example of FIG. 19 may be the same or substantially the same as the example of FIG. 14, except that operation S1100 is omitted.

FIGS. 20, 21, and 22 are flowcharts illustrating a method of operating a storage device according to example embodiments.

Referring to FIG. 20, an example where the method of managing metadata of FIG. 1 is described by focusing on an operation of a storage device is illustrated.

For example, in a method of operating a storage device according to example embodiments, a first sorted string table having a first structure is received such that a plurality of top-level index information are included in a unified top-level block, a plurality of filter information and a plurality of data index information are included in a plurality of unified partition blocks, at least one filter information and at least one data index information are included in one unified partition block, and a plurality of key-value pairs are included in a plurality of data blocks (operation S2100). The plurality of key-value pairs are used in key-value store based on LSM-tree, the plurality of filter information and the plurality of data index information correspond to the plurality of key-value pairs, and the plurality of top-level index information correspond to the plurality of filter information and the plurality of data index information. The first sorted string table is stored (operation S2200). For example, operation S2100 may correspond to operations S100, S200, and S300 in FIG. 1, and operation S2200 may correspond to operation S400 in FIG. 1.

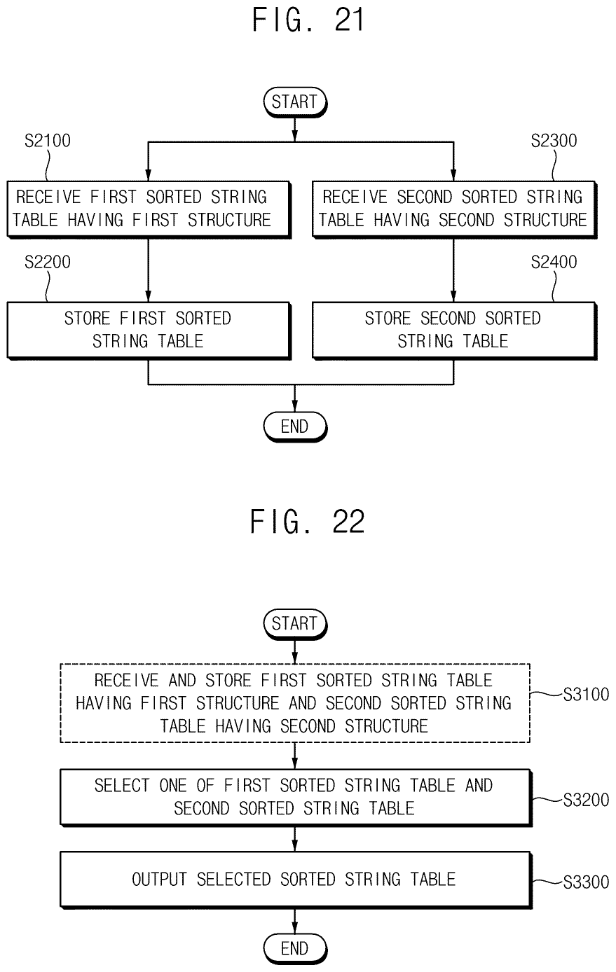

Referring to FIG. 21, an example where the method of managing metadata of FIG. 11 is described by focusing on an operation of a storage device is illustrated.

For example, in a method of operating a storage device according to example embodiments, operations S2100 and S2200 may be the same or substantially the same as those described with reference to FIG. 20. A second sorted string table having a second structure different from the first structure is received such that the plurality of filter information are included in a filter block, the plurality of data index information are included in a data index block, and the plurality of key-value pairs are included in a plurality of data blocks (operation S2300). The second sorted string table is stored (operation S2400). For example, operation S2300 may correspond to operation S500 in FIG. 11, and operation S2400 may correspond to operation S600 in FIG. 11.

Referring to FIG. 22, an example where the method of managing metadata of FIG. 14 and/or FIG. 19 is described by focusing on an operation of a storage device is illustrated.

For example, in a method of operating a storage device according to example embodiments, a first sorted string table having a first structure and a second sorted string table having a second structure are generated and stored (operation S3100), one of the first sorted string table and the second sorted string table is selected (operation S3200), and a selected sorted string table is output to perform a metadata caching operation (operation S3300). For example, operation S3100 may correspond to operation S1100 in FIG. 14, and operations S3200 and S3300 may correspond to operations S1200 and S1300 in FIGS. 14 and 19.

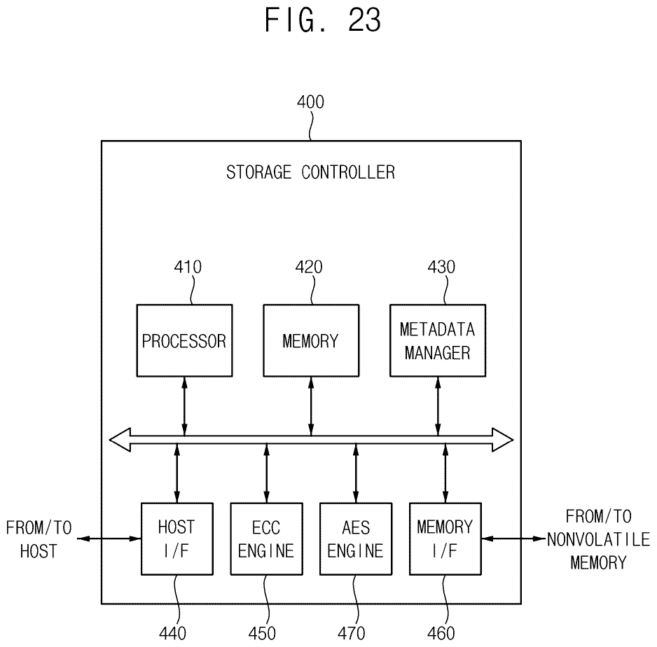

FIG. 23 is a block diagram illustrating an example of a storage controller included in a storage device according to example embodiments.

Referring to FIG. 23, a storage controller 400 may include a processor 410, a memory 420, a metadata manager 430, a host interface 440, an error correction code (ECC) engine 450, a memory interface 460, and an advanced encryption standard (AES) engine 470.

The processor 410 may control an operation of the storage controller 400 in response to a request received via the host interface 440 from a host device (e.g., the host device 200 in FIG. 2). For example, the processor 410 may control an operation of a storage device (e.g., the storage device 300 in FIG. 2), and may control respective components by employing firmware for operating the storage device.

The memory 420 may store instructions and data executed and processed by the processor 410. For example, the memory 420 may be implemented with a volatile memory, such as a DRAM, a static random access memory (SRAM), and/or the like.

The metadata manager 430 may be used to perform the method of managing metadata according to example embodiments and the method of operating the storage device according to example embodiments. The metadata manager 430 may be the same or substantially the same as the metadata manager 312 in FIG. 2.

The ECC engine 450 for error correction may perform coded modulation using a Bose-Chaudhuri-Hocquenghem (BCH) code, a low density parity check (LDPC) code, a turbo code, a Reed-Solomon code, a convolution code, a recursive systematic code (RSC), a trellis-coded modulation (TCM), a block coded modulation (BCM), etc., and/or may perform ECC encoding and ECC decoding using above-described codes or other error correction codes.

The host interface 440 may provide physical connections between the host device and the storage device. The host interface 440 may provide an interface corresponding to a bus format of the host device for communication between the host device and the storage device.

The memory interface 460 may exchange data with a nonvolatile memory (e.g., the nonvolatile memories 320a, 320b, and 320c in FIG. 2). The memory interface 460 may transfer data to the nonvolatile memory, or may receive data read from the nonvolatile memory. For example, the memory interface 460 may be configured to comply with a standard protocol, such as Toggle or open NAND flash interface (ONFI).

The AES engine 470 may perform at least one of an encryption operation and a decryption operation on data input to the storage controller 400 by using a symmetric-key algorithm. Although not illustrated in detail, the AES engine 470 may include an encryption module and a decryption module.

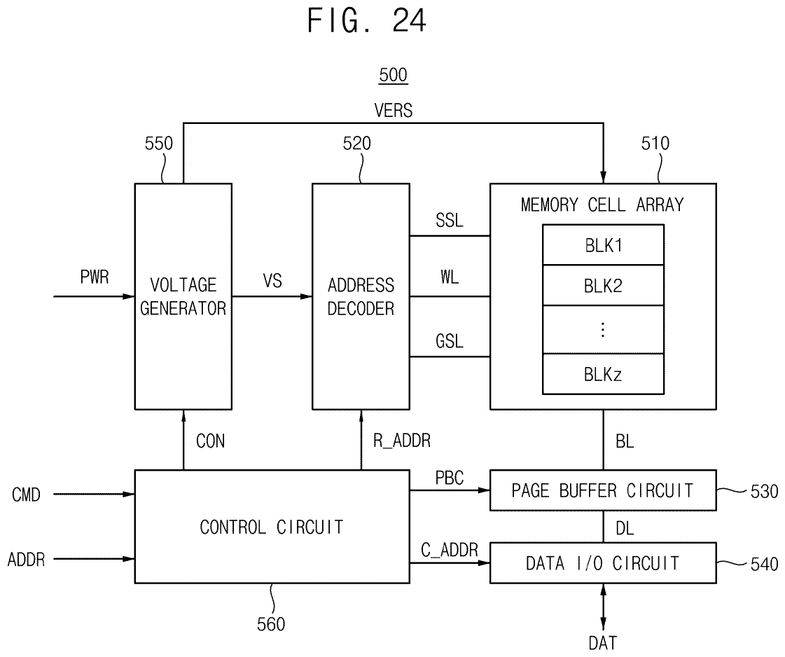

FIG. 24 is a block diagram illustrating an example of a nonvolatile memory included in a storage device according to example embodiments.

Referring to FIG. 24, a nonvolatile memory 500 includes a memory cell array 510, an address decoder 520, a page buffer circuit 530, a data input/output (I/O) circuit 540, a voltage generator 550, and a control circuit 560.

The memory cell array 510 is connected to the address decoder 520 via a plurality of string selection lines SSL, a plurality of wordlines WL, and a plurality of ground selection lines GSL. The memory cell array 510 is further connected to the page buffer circuit 530 via a plurality of bitlines BL. The memory cell array 510 may include a plurality of memory cells (e.g., a plurality of nonvolatile memory cells) that are connected to the plurality of wordlines WL and the plurality of bitlines BL. The memory cell array 510 may be divided into a plurality of memory blocks BLK1, BLK2, . . . , BLKz each of which includes memory cells. In addition, each of the plurality of memory blocks BLK1 to BLKz may be divided into a plurality of pages.

In some example embodiments, the plurality of memory cells included in the memory cell array 510 may be arranged in a two-dimensional (2D) array structure or a three-dimensional (3D) vertical array structure. The 3D vertical array structure may include vertical cell strings that are vertically oriented such that at least one memory cell is located over another memory cell. The at least one memory cell may comprise a charge trap layer. The following patent documents, which are hereby incorporated by reference in their entireties, describe configurations for a memory cell array including a 3D vertical array structure, in which the three-dimensional memory array is configured as a plurality of levels, with wordlines and/or bitlines shared between levels: U.S. Pat. Nos. 7,679,133; 8,553,466; 8,654,587; 8,559,235; and U.S. Pat. Pub. No. 2011/0233648.

The control circuit 560 receives a command CMD and an address ADDR from an outside (e.g., from the storage controller 310 in FIG. 2), and controls erasure, programming and read operations of the nonvolatile memory 500 based on the command CMD and the address ADDR. An erasure operation may include performing a sequence of erase loops, and a program operation may include performing a sequence of program loops. Each program loop may include a program operation and a program verification operation. Each erase loop may include an erase operation and an erase verification operation. The read operation may include a normal read operation and data recovery read operation.

For example, the control circuit 560 may generate control signals CON, which are used for controlling the voltage generator 550, and may generate a control signal PBC for controlling the page buffer circuit 530, based on the command CMD, and may generate a row address R_ADDR and a column address C_ADDR based on the address ADDR. The control circuit 560 may provide the row address R_ADDR to the address decoder 520 and may provide the column address C_ADDR to the data I/O circuit 540.

The address decoder 520 may be connected to the memory cell array 510 via the plurality of string selection lines SSL, the plurality of wordlines WL and the plurality of ground selection lines GSL. For example, in the data erase/write/read operations, the address decoder 520 may determine at least one of the plurality of wordlines WL as a selected wordline, may determine at least one of the plurality of string selection lines SSL as a selected string selection line, and may determine at least one of the plurality of ground selection lines GSL as a selected ground selection line, based on the row address R_ADDR.

The voltage generator 550 may generate voltages VS that are used for an operation of the nonvolatile memory 500 based on a power PWR and the control signals CON. The voltages VS may be applied to the plurality of string selection lines SSL, the plurality of wordlines WL, and the plurality of ground selection lines GSL via the address decoder 520. In addition, the voltage generator 550 may generate an erase voltage VERS that is used for the data erase operation based on the power PWR and the control signals CON. The erase voltage VERS may be applied to the memory cell array 510 directly or via the bitline BL.

The page buffer circuit 530 may be connected to the memory cell array 510 via the plurality of bitlines BL. The page buffer circuit 530 may include a plurality of page buffers including a plurality of latches. The page buffer circuit 530 may store data DAT to be programmed into the memory cell array 510 or may read data DAT sensed from the memory cell array 510. In other words, the page buffer circuit 530 may operate as a write driver or a sensing amplifier depending on an operation mode of the nonvolatile memory 500.

The data I/O circuit 540 may be connected to the page buffer circuit 530 via data lines DL. The data I/O circuit 540 may provide the data DAT from the outside of the nonvolatile memory 500 to the memory cell array 510 via the page buffer circuit 530 or may provide the data DAT from the memory cell array 510 to the outside of the nonvolatile memory 500, based on the column address C_ADDR.

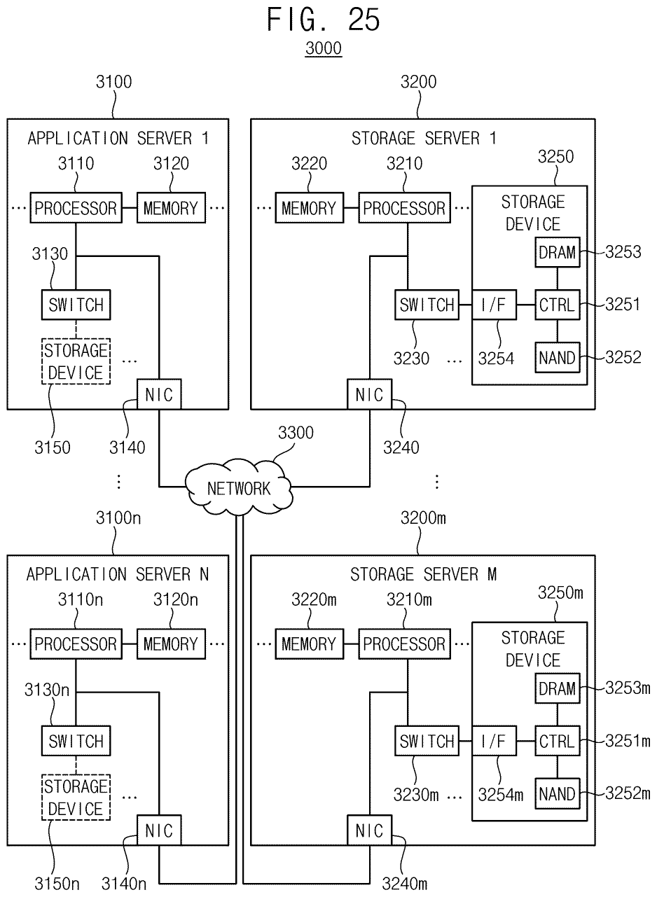

FIG. 25 is a block diagram illustrating a data center including a storage device according to example embodiments.

Referring to FIG. 25, a data center 3000 may be a facility that collects various types of data and provides various services, and may be referred to as a data storage center. The data center 3000 may be a system for operating search engines and databases, and may be a computing system used by companies such as banks or government agencies. The data center 3000 may include application servers 3100 to 3100n and storage servers 3200 to 3200m. The number of the application servers 3100 to 3100n and the number of the storage servers 3200 to 3200m may be variously selected according to example embodiments, and the number of the application servers 3100 to 3100n and the number of the storage servers 3200 to 3200m may be different from each other.

The application server 3100 may include at least one processor 3110 and at least one memory 3120, and the storage server 3200 may include at least one processor 3210 and at least one memory 3220. An operation of the storage server 3200 will be described as an example. The processor 3210 may control overall operations of the storage server 3200, and may access the memory 3220 to execute instructions and/or data loaded in the memory 3220. The memory 3220 may include at least one of a double data rate (DDR) synchronous dynamic random access memory (SDRAM), a high bandwidth memory (HBM), a hybrid memory cube (HMC), a dual in-line memory module (DINM), an Optane DIMM, a nonvolatile DIMM (NVDIMM), etc. The number of the processors 3210 and the number of the memories 3220 included in the storage server 3200 may be variously selected according to example embodiments. In some example embodiments, the processor 3210 and the memory 3220 may provide a processor-memory pair. In some example embodiments, the number of the processors 3210 and the number of the memories 3220 may be different from each other. The processor 3210 may include a single core processor or a multiple core processor. The above description of the storage server 3200 may be similarly applied to the application server 3100. The application server 3100 may include at least one storage device 3150, and the storage server 3200 may include at least one storage device 3250. In some example embodiments, the application server 3100 may not include the storage device 3150. The number of the storage devices 3250 included in the storage server 3200 may be variously selected according to example embodiments.

The application servers 3100 to 3100n and the storage servers 3200 to 3200m may communicate with each other through a network 3300. The network 3300 may be implemented using a fiber channel (FC) or an Ethernet. The FC may be a medium used for a relatively high speed data transmission, and an optical switch that provides high performance and/or high availability may be used. The storage servers 3200 to 3200m may be provided as file storages, block storages, and/or object storages according to an access scheme of the network 3300.

In some example embodiments, the network 3300 may be a storage-only network or a network dedicated to a storage such as a storage area network (SAN). For example, the SAN may be an FC-SAN that uses an FC network and is implemented according to an FC protocol (FCP). For another example, the SAN may be an IP-SAN that uses a transmission control protocol/internet protocol (TCP/IP) network and is implemented according to an iSCSI (a SCSI over TCP/IP or an Internet SCSI) protocol. In other example embodiments, the network 3300 may be a general network such as the TCP/IP network. For example, the network 3300 may be implemented according to at least one of protocols such as an FC over Ethernet (FCoE), a network attached storage (NAS), a nonvolatile memory express (NVMe) over Fabrics (NVMe-oF), etc.

Hereinafter, example embodiments will be described based on the application server 3100 and the storage server 3200. The description of the application server 3100 may be applied to the other application server 3100n, and the description of the storage server 3200 may be applied to the other storage server 3200m.

The application server 3100 may store data requested to be stored by a user or a client into one of the storage servers 3200 to 3200m through the network 3300. In addition, the application server 3100 may obtain data requested to be read by the user or the client from one of the storage servers 3200 to 3200m through the network 3300. For example, the application server 3100 may be implemented as a web server or a database management system (DBMS).

The application server 3100 may access a memory 3120n or a storage device 3150n included in the other application server 3100n through the network 3300, and/or may access the memories 3220 to 3220m or the storage devices 3250 to 3250m included in the storage servers 3200 to 3200m through the network 3300. Thus, the application server 3100 may perform various operations on data stored in the application servers 3100 to 3100n and/or the storage servers 3200 to 3200m. For example, the application server 3100 may execute a command for moving or copying data between the application servers 3100 to 3100n and/or the storage servers 3200 to 3200m. The data may be transferred from the storage devices 3250 to 3250m of the storage servers 3200 to 3200m to the memories 3120 to 3120n of the application servers 3100 to 3100n directly or through the memories 3220 to 3220m of the storage servers 3200 to 3200m. For example, the data transferred through the network 3300 may be encrypted data for security or privacy.

In the storage server 3200, an interface 3254 of the storage device 3250 may provide a physical connection between the processor 3210 and a controller 3251 of the storage device 3250 and/or a physical connection between a network interface card (NIC) 3240 and the controller 3251. For example, the interface 3254 may be implemented based on a direct attached storage (DAS) scheme in which the storage device 3250 is directly connected with a dedicated cable. For example, the interface 3254 may be implemented based on at least one of various interface schemes such as an advanced technology attachment (ATA), a serial ATA (SATA) an external SATA (e-SATA), a small computer system interface (SCSI), a serial attached SCSI (SAS), a peripheral component interconnection (PCI), a PCI express (PCIe), an NVMe, a compute express link (CXL), an IEEE 1394, a universal serial bus (USB), a secure digital (SD) card interface, a multi-media card (MMC) interface, an embedded MMC (eMMC) interface, a universal flash storage (UFS) interface, an embedded UFS (eUFS) interface, a compact flash (CF) card interface, etc.

The storage server 3200 may further include a switch 3230 and the NIC 3240. The switch 3230 may selectively connect the processor 3210 with the storage device 3250 or may selectively connect the NIC 3240 with the storage device 3250 under a control of the processor 3210. Similarly, the application server 3100 may further include a switch 3130 and an NIC 3140.

In some example embodiments, the NIC 3240 may include a network interface card, a network adapter, and/or the like. The NIC 3240 may be connected to the network 3300 through a wired interface, a wireless interface, a Bluetooth interface, an optical interface, and/or the like. The NIC 3240 may further include an internal memory, a digital signal processor (DSP), a host bus interface, and/or the like, and may be connected to the processor 3210 and/or the switch 3230 through the host bus interface. The host bus interface may be implemented as one of the above-described examples of the interface 3254. In some example embodiments, the NIC 3240 may be integrated with at least one of the processor 3210, the switch 3230, and the storage device 3250.

In the storage servers 3200 to 3200m and/or the application servers 3100 to 3100n, the processor may transmit a command to the storage devices 3150 to 3150n and 3250 to 3250m or the memories 3120 to 3120n and 3220 to 3220m to program or read data. For example, the data may be error-corrected data by an error correction code (ECC) engine. For example, the data may be processed by a data bus inversion (DBI) or a data masking (DM), and may include a cyclic redundancy code (CRC) information. For example, the data may be encrypted data for security or privacy.

The storage devices 3150 to 3150m and 3250 to 3250m may transmit a control signal and command/address signals to NAND flash memory devices 3252 to 3252m of the storage devices 3250 and 3250m in response to a read command received from the processor. When data is read from the NAND flash memory devices 3252 to 3252m, a read enable (RE) signal may be input as a data output control signal and may serve to output data to a DQ bus. A data strobe signal (DQS) may be generated using the RE signal. The command and address signals may be latched in a page buffer based on a rising edge or a falling edge of a write enable (WE) signal.

The controller 3251 may control overall operations of the storage device 3250. In some example embodiments, the controller 3251 may include a static random access memory (SRAM). The controller 3251 may write data into the NAND flash memory device 3252 in response to a write command, or may read data from the NAND flash memory device 3252 in response to a read command. For example, the write command and/or the read command may be provided from the processor 3210 in the storage server 3200, the processor 3210m in the other storage server 3200m, or the processors 3110 to 3110n in the application servers 3100 to 3100n. A DRAM 3253 in the storage device 3250 may temporarily store (e.g., may buffer) data to be written to the NAND flash memory device 3252 or data read from the NAND flash memory device 3252. Further, the DRAM 3253 may store metadata. The metadata may be data generated by the controller 3251 to manage user data or the NAND flash memory device 3252.

Each of the storage devices 3250 to 3250m may be the storage device according to example embodiments, and may perform the method of managing metadata according to example embodiments and/or the method of operating the storage device according to example embodiments.

The example embodiments may be applied to various electronic devices and systems that include the storage devices and the storage systems. For example, the example embodiments may be applied to systems such as a personal computer (PC), a server computer, a data center, a workstation, a mobile phone, a smart phone, a tablet computer, a laptop computer, a personal digital assistant (PDA), a portable multimedia player (PMP), a digital camera, a portable game console, a music player, a camcorder, a video player, a navigation device, a wearable device, an internet of things (IoT) device, an internet of everything (IoE) device, an e-book reader, a virtual reality (VR) device, an augmented reality (AR) device, a robotic device, a drone, an automotive, etc.

When the terms “about” or “substantially” are used in this specification in connection with a numerical value, it is intended that the associated numerical value includes a manufacturing or operational tolerance (e.g., ±10%) around the stated numerical value. Moreover, when the words “generally” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

Any or all of the elements described with reference to the figures may communicate with any or all other elements described with reference to figures. For example, any element may engage in one-way and/or two-way and/or broadcast communication with any or all other elements in the figures, to transfer and/or exchange and/or receive information such as but not limited to data and/or commands, in a manner such as in a serial and/or parallel manner, via a bus such as a wireless and/or a wired bus (not illustrated). The information may be in encoded various formats, such as in an analog format and/or in a digital format.

As described herein, any electronic devices and/or portions thereof according to any of the example embodiments may include, may be included in, and/or may be implemented by one or more instances of processing circuitry such as hardware including logic circuits; a hardware/software combination such as a processor executing software; or any combination thereof. For example, the processing circuitry more specifically may include, but is not limited to, a central processing unit (CPU), an arithmetic logic unit (ALU), a graphics processing unit (GPU), an application processor (AP), a digital signal processor (DSP), a microcomputer, a field programmable gate array (FPGA), and programmable logic unit, a microprocessor, application-specific integrated circuit (ASIC), a neural network processing unit (NPU), an Electronic Control Unit (ECU), an Image Signal Processor (ISP), and the like. In some example embodiments, the processing circuitry may include a non-transitory computer readable storage device (e.g., a memory), for example a DRAM device, storing a program of instructions, and a processor (e.g., CPU) configured to execute the program of instructions to implement the functionality and/or methods performed by some or all of any devices, systems, modules, units, controllers, circuits, architectures, and/or portions thereof according to any of the example embodiments, and/or any portions thereof.

According to example embodiments, in a method of managing metadata in key-value, store a plurality of key-value pairs in a memory table, generate a plurality of filter information, a plurality of data index information and a plurality of top-level index information, generate a first sorted string table having a first structure and a second sorted string table having a second structure different from the first structure and store the first sorted string table and the second sorted string table. The first sorted string table having the first structure is implemented such that the plurality of top-level index information are included in a unified top-level block, the plurality of filter information and the plurality of data index information are included in a plurality of unified partition blocks, at least one filter information and at least one data index information are included in one unified partition block, and the plurality of key-value pairs are included in a plurality of data blocks. The second sorted string table having the second structure is implemented such that the plurality of filter information are included in a filter block, the plurality of data index information are included in a data index block, and the plurality of key-value pairs are included in the plurality of data blocks. The first sorted string table is stored. Monitor, based on read requests being processed, access information for the first sorted string table and the second sorted string table in order to perform a cost-benefit analysis for the first sorted string table and the second sorted string table based on a result of monitoring the access information, select one of the first sorted string table and the second sorted string table based on a result of the cost-benefit analysis, and provide a selected sorted string table to the host device. Perform a metadata caching operation using the selected sorted string table.

According to example embodiments, in the method of managing metadata in key-value, the cost-benefit analysis is performed based on a change in time for processing the read requests.

The foregoing is illustrative of example embodiments and is not to be construed as limiting thereof. Although some example embodiments have been described, those skilled in the art will readily appreciate that many modifications are possible in the example embodiments without materially departing from the novel teachings and advantages of the example embodiments. Accordingly, all such modifications are intended to be included within the scope of the example embodiments as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of managing metadata in key-value store based on log-structured merge tree (LSM-tree), the method comprising:
sequentially storing a plurality of key-value pairs in a memory table;
generating a plurality of filter information, a plurality of data index information, and a plurality of top-level index information, the plurality of filter information and the plurality of data index information corresponding to the plurality of key-value pairs, the plurality of top-level index information corresponding to the plurality of filter information and the plurality of data index information;
generating a first sorted string table having a first structure such that the plurality of top-level index information are included in a unified top-level block, the plurality of filter information and the plurality of data index information are included in a plurality of unified partition blocks, at least one filter information and at least one data index information are included in one unified partition block, and the plurality of key-value pairs are included in a plurality of data blocks; and
storing the first sorted string table.

2. The method of claim 1, wherein generating the first sorted string table includes:
allocating first top-level index information among the plurality of top-level index information to the unified top-level block, the first top-level index information corresponding to a first key-value pair among the plurality of key-value pairs;
allocating first filter information among the plurality of filter information and first data index information among the plurality of data index information to a first unified partition block among the plurality of unified partition blocks, the first filter information and the first data index information corresponding to the first key-value pair; and
allocating the first key-value pair to a first data block among the plurality of data blocks.

3. The method of claim 2, wherein generating the first sorted string table further includes:
allocating second top-level index information among the plurality of top-level index information to the unified top-level block, the second top-level index information corresponding to a second key-value pair subsequent to the first key-value pair among the plurality of key-value pairs;
allocating second filter information among the plurality of filter information and second data index information among the plurality of data index information to the first unified partition block or a second unified partition block subsequent to the first unified partition block among the plurality of unified partition blocks, the second filter information and the second data index information corresponding to the second key-value pair; and
allocating the second key-value pair to the first data block or a second data block subsequent to the first data block among the plurality of data blocks.

4. The method of claim 3, wherein allocating the second filter information and the second data index information to the first unified partition block or the second unified partition block includes:
allocating the second filter information and the second data index information to the first unified partition block, based on an available storage space of the first unified partition block being sufficient to store the second filter information and the second data index information; and
allocating the second filter information and the second data index information to the second unified partition block, based on the available storage space of the first unified partition block being insufficient to store the second filter information and the second data index information.

5. The method of claim 2, wherein first offset information corresponding to the first filter information is additionally allocated to the first unified partition block.

6. The method of claim 1, further comprising:
generating a second sorted string table having a second structure different from the first structure such that the plurality of filter information are included in a filter block, the plurality of data index information are included in a data index block, and the plurality of key-value pairs are included in the plurality of data blocks; and
storing the second sorted string table.

7. The method of claim 6, further comprising:
selecting one of the first sorted string table and the second sorted string table; and
performing a metadata caching operation using a selected sorted string table.

8. The method of claim 7, wherein selecting one of the first sorted string table and the second sorted string table includes:
monitoring access information for the first sorted string table and the second sorted string table, based on read requests being processed;
performing a cost-benefit analysis for the first sorted string table and the second sorted string table based on a result of monitoring the access information; and
setting one of the first sorted string table and the second sorted string table as the selected sorted string table based on a result of the cost-benefit analysis.

9. The method of claim 8, wherein the cost-benefit analysis is performed based on a change in time for processing the read requests.

10. The method of claim 9, wherein one of the first sorted string table and the second sorted string table is selected such that the time for processing the read requests is reduced.

11. The method of claim 8, wherein the result of monitoring the access information includes access time information based on cache hits and cache misses occurring, cache miss rate information, and utilization ratio information of the first sorted string table and the second sorted string table.

12. The method of claim 7,
wherein the second sorted string table is selected based on a size of an available storage space for the metadata caching operation being greater than a reference size, and
wherein the first sorted string table is selected based on the size of the available storage space for the metadata caching operation being less than or equal to the reference size.

13. The method of claim 7,
wherein the second sorted string table is selected based on an access frequency for the plurality of key-value pairs being greater than a reference frequency, and
wherein the first sorted string table is selected based on the access frequency for the plurality of key-value pairs being less than or equal to the reference frequency.

14. The method of claim 7,
wherein an entirety of the second sorted string table is cached in an available storage space for the metadata caching operation based on the second sorted string table being selected, and
wherein a portion of the first sorted string table is cached in the available storage space for the metadata caching operation based on the first sorted string table being selected.

15. The method of claim 7, wherein the selected sorted string table is changeable during operation.

16. A storage device comprising:
a storage controller configured to receive a first sorted string table having a first structure such that a plurality of top-level index information are included in a unified top-level block, a plurality of filter information and a plurality of data index information are included in a plurality of unified partition blocks, at least one filter information and at least one data index information are included in one unified partition block, and a plurality of key-value pairs are included in a plurality of data blocks, the plurality of key-value pairs being used in key-value store based on log-structured merge tree (LSM-tree), the plurality of filter information and the plurality of data index information corresponding to the plurality of key-value pairs, the plurality of top-level index information corresponding to the plurality of filter information and the plurality of data index information; and
a plurality of nonvolatile memories configured to store the first sorted string table, the storage controller configured to control the plurality of nonvolatile memories.

17. The storage device of claim 16,
wherein the storage controller is configured to further receive a second sorted string table having a second structure different from the first structure such that the plurality of filter information are included in a filter block, the plurality of data index information are included in a data index block, and the plurality of key-value pairs are included in the plurality of data blocks, and
wherein the plurality of nonvolatile memories are configured to further store the second sorted string table.

18. The storage device of claim 17, wherein the storage controller is configured to
select one of the first sorted string table and the second sorted string table, and
output a selected sorted string table to perform a metadata caching operation.

19. The storage device of claim 18, wherein the storage controller is configured to
receive a result of monitoring access information for the first sorted string table and the second sorted string table,
perform a cost-benefit analysis for the first sorted string table and the second sorted string table based on the result of monitoring the access information, and
set one of the first sorted string table and the second sorted string table as the selected sorted string table based on a result of the cost-benefit analysis.

20. A storage system comprising:
a host device configured to sequentially
store a plurality of key-value pairs in a memory table,
generate a plurality of filter information, a plurality of data index information and a plurality of top-level index information, and
generate a first sorted string table having a first structure and a second sorted string table having a second structure different from the first structure; and
a storage device configured to store the first sorted string table and the second sorted string table,
the first sorted string table having the first structure is implemented such that the plurality of top-level index information are included in a unified top-level block, the plurality of filter information and the plurality of data index information are included in a plurality of unified partition blocks, at least one filter information and at least one data index information are included in one unified partition block, and the plurality of key-value pairs are included in a plurality of data blocks,
the second sorted string table having the second structure is implemented such that the plurality of filter information are included in a filter block, the plurality of data index information are included in a data index block, and the plurality of key-value pairs are included in the plurality of data blocks,
the host device configured to monitor access information for the first sorted string table and the second sorted string table based on read requests being processed,
the storage device configured to
perform a cost-benefit analysis for the first sorted string table and the second sorted string table based on a result of monitoring the access information,
select one of the first sorted string table and the second sorted string table based on a result of the cost-benefit analysis, and
provide a selected sorted string table to the host device, and
the host device configured to perform a metadata caching operation using the selected sorted string table.
